(19) United States
(12) Patent Application Publication
(10) Pub. No.: US 2019/0065012 A1
(43) Pub. Date: Feb. 28, 2019

(54) METHOD, APPARATUS, AND COMPUTER-READABLE MEDIUM FOR PROPAGATING ENRICHED NOTE DATA OBJECTS OVER A WEB SOCKET CONNECTION IN A NETWORKED COLLABORATION WORKSPACE

(71) Applicant: Re Mago Holding LTD, London (GB)

(72) Inventor: Marco Valerio Masi, Lugano Paradiso (CH)

(21) Appl. No.: 16/054,328

(22) Filed: Aug. 3, 2018

Related U.S. Application Data
(63) Continuation-in-part of application No. 15/685,533, filed on Aug. 24, 2017.

(51) Int. Cl. G06F 3/0482; H04L 29/06; H04L 29/08; G06F 21/62

(52) U.S. Cl. CPC G06F 3/0482; H04L 65/403; G06F 3/167; G06F 21/6218; H04L 63/08; H04L 67/06

(57) ABSTRACT

A system, method and computer-readable medium for propagating enriched note data objects over a web socket connection in a networked collaboration workspace, including transmitting a representation of a collaboration workspace accessible to participants on computing devices over a web socket connection, generating an enriched note data object comprising text, user-accessible controls, and a content file and being configured to display the text and the user-accessible controls and open the content file in response to selection of a display control, detecting a user input associating the enriched note data object with a selected position in the representation of the collaboration workspace, and transmitting the enriched note data object, the selected position, and commands to the server over a web socket connection, the commands being configured to cause the server to propagate the enriched note data object and the selected position to the computing devices.

This application is a continuation-in-part of U.S. application Ser. No. 15/685,533, titled “METHOD, APPARATUS, AND COMPUTER-READABLE MEDIUM FOR IMPLEMENTATION OF A UNIVERSAL HARDWARE-SOFTWARE INTERFACE” and filed Aug. 24, 2017, the disclosure of which is hereby incorporated by reference in its entirety.

### BACKGROUND

Operating systems and applications executing within operating systems frequently make use of external hardware devices to allow users to provide input to the program and to provide output to users. Common examples of external hardware devices include a keyboard, a computer mouse, a microphone, and external speakers. These external hardware devices interface with the operating system through the use of drivers, which are specialized software programs configured to interface between the hardware commands used by a particular hardware device and the operating system.

Applications will sometimes be designed to interface with certain hardware devices. For example, a voice-to-text word processing application can be designed to interface with an audio headset including a microphone. In this case, the application must be specifically configured to receive voice commands, perform voice recognition, convert the recognized words into textual content, and output the textual content into a document. This functionality will typically be embodied in the application's Application Programming Interface (API), which is a set of defined methods of communication between various software components. In the example of the voice recognition application, the API can include an interface between the application program and software on a driver that is responsible for interfacing with the hardware device (the microphone) itself.

One problem with existing software that makes use of specialized hardware devices is that the application or operating system software itself must be customized and specially designed in order to utilize the hardware device. This customization means that the hardware device cannot exceed the scope defined for it by the application and cannot be utilized for contexts outside the specific application for which it was designed to be used. For example, a user of the voice-to-text word processing application could not manipulate other application programs or other components within the operating system using voice commands unless those other application programs or the operating system were specifically designed to make use of voice commands received over the microphone.

FIG. 1 illustrates an example of the existing architecture of systems which make use of coupled hardware devices for user input. The operating system 100A of FIG. 1 includes executing applications 101A and 102A, each of which have their own APIs, 101B and 102B, respectively. The operating system 100A also has its own API 100B, as well as specialized drivers 100C, 101C, and 102C, configured to interface with hardware devices 100D, 101D, and 102D.

As shown in FIG. 1, application API 101B is configured to interface with driver 101C which itself interfaces with hardware device 101D. Similarly, application API 102B is configured to interface with driver 102C which itself interfaces with hardware device 102D. At the operating system level, the operating system API 100B is configured to interface with driver 100C, which itself interfaces with hardware device 100D.

The architecture of the system shown in FIG. 1 limits the ability of users to utilize hardware devices outside of certain application or operating system contexts. For example, a user could not utilize hardware device 101D to provide input to application 102A and could not utilize hardware device 102D to provide input to application 101A or to the operating system 100A.

Accordingly, improvements are needed in hardware-software interfaces which allow for utilization of hardware devices in multiple software contexts.

### BRIEF DESCRIPTION OF THE DRAWINGS

FIG. 1 illustrates an example of the existing architecture of systems which make use of coupled hardware devices for user input.

FIG. 2 illustrates the architecture of a system utilizing the universal hardware-software interface according to an exemplary embodiment.

FIG. 3 illustrates a flowchart for implementation of a universal hardware-software interface according to an exemplary embodiment.

FIG. 4 illustrates a flowchart for determining a user input based at least in part on information captured by one or more hardware devices communicatively coupled to the system when the information captured by the one or more hardware devices comprises one or more images according to an exemplary embodiment.

FIG. 5A illustrates an example of object recognition according to an exemplary embodiment.

FIG. 5B illustrates an example of determining input location coordinates according to an exemplary embodiment.

FIG. 6 illustrates a flowchart for determining a user input based at least in part on information captured by one or more hardware devices communicatively coupled to the system when the captured information is sound information according to an exemplary embodiment.

FIG. 7 illustrates a tool interface that can be part of the transparent layer according to an exemplary embodiment.

FIG. 8 illustrates an example of a stylus that can be part of the system according to an exemplary embodiment.

FIG. 9 illustrates a flowchart for identifying a context corresponding to the user input according to an exemplary embodiment.

FIG. 10 illustrates an example of using the input coordinates to determine a context according to an exemplary embodiment.

FIG. 11 illustrates a flowchart for converting user input into transparent layer commands according to an exemplary embodiment.

FIG. 12A illustrates an example of receiving input coordinates when the selection mode is toggled according to an exemplary embodiment.

FIG. 12B illustrates an example of receiving input coordinates when the pointing mode is toggled according to an exemplary embodiment.

FIG. 12C illustrates an example of receiving input coordinates when the drawing mode is toggled according to an exemplary embodiment.

FIG. 13 illustrates an example of a transparent layer command determined based on one or more words identified in input voice data according to an exemplary embodiment.

FIG. 14 illustrates another example of a transparent layer command determined based on one or more words identified in input voice data according to an exemplary embodiment.

FIG. 15 illustrates a flowchart for executing the one or more transparent layer commands on the transparent layer according to an exemplary embodiment.

FIG. 16 illustrates an example interface for adding new commands corresponding to user input according to an exemplary embodiment.

FIG. 17 illustrates various components and options of a drawing interface and draw mode according to an exemplary embodiment.

FIG. 18 illustrates a calibration and settings interface for a video camera hardware device that is used to recognize objects and allows for a user to provide input using touch and gestures according to an exemplary embodiment.

FIG. 19 illustrates a general settings interface that allows a user to customize various aspects of the interface, toggle input modes, and make other changes according to an exemplary embodiment.

FIG. 20 illustrates a flowchart for propagating enriched note data objects over a web socket connection in a networked collaboration workspace according to an exemplary embodiment.

FIG. 21A illustrates the network architecture used to host and transmit collaboration workspace according to an exemplary embodiment.

FIG. 21B illustrates the process for propagating edits to the collaboration workspace within the network according to an exemplary embodiment.

FIG. 22 illustrates multiple representations of a collaboration workspace according to an exemplary embodiment.

FIGS. 23A-23B illustrate a process used to generate the enriched note data object within a networked collaboration workspace according to an exemplary embodiment.

FIG. 24 illustrates a generated enriched note 2400 according to an exemplary embodiment.

FIGS. 25A-25B illustrate an example of detecting a user input associating the enriched note data object with a selected position in the representation of the collaboration workspace according to an exemplary embodiment.

FIG. 26 illustrates the process for propagating the enriched note data object according to an exemplary embodiment.

FIG. 27 illustrates the enriched note on multiple instances of a collaboration workspace according to an exemplary embodiment.

FIGS. 28-32 illustrate examples of user interaction with enriched notes according to an exemplary embodiment.

FIG. 33 illustrates an exemplary computing environment configured to carry out the disclosed methods.

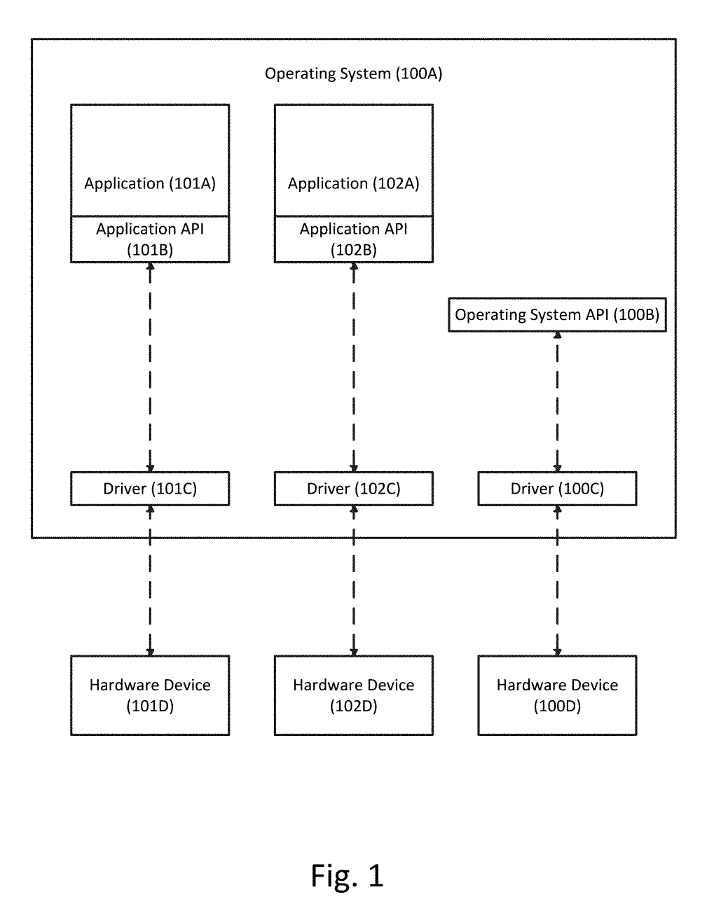

### DETAILED DESCRIPTION

While methods, apparatuses, and computer-readable media are described herein by way of examples and embodiments, those skilled in the art recognize that methods, apparatuses, and computer-readable media for implementation of a universal hardware-software interface are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

Applicant has discovered a method, apparatus, and computer-readable medium that solves the problems associated with previous hardware-software interfaces used for hardware devices. In particular, Applicant has developed a universal hardware-software interface which allows users to utilize communicatively-coupled hardware devices in a variety of software contexts. The disclosed implementation removes the need for applications or operating systems to be custom designed to interface with a particular hardware device through the use of a specialized virtual driver and a corresponding transparent layer, as is described below in greater detail.

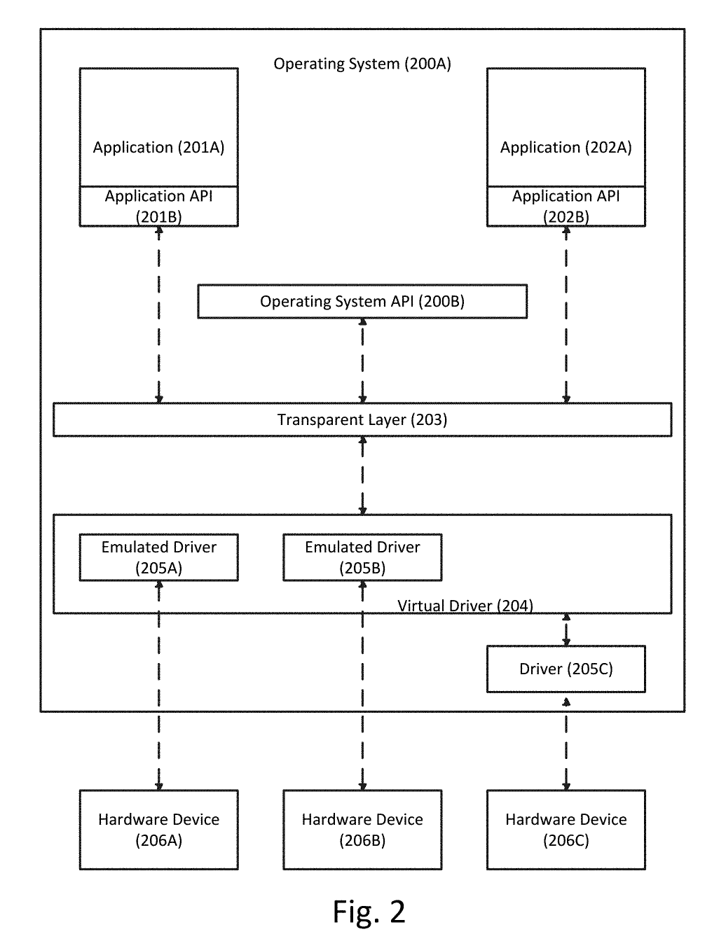

FIG. 2 illustrates the architecture of a system utilizing the universal hardware-software interface according to an exemplary embodiment. As shown in FIG. 2, the operating system 200A includes a transparent layer 203 which communicates a virtual driver 204. As will be explained in greater detail below, the transparent layer 203 is an API configured to interface between a virtual driver and an operating system and/or application(s) executing on the operating system. In this example, the transparent layer 203 interfaces between the virtual driver 204 and API 201B of application 201A, API 202 B of application 202A, and operating system API 200B of operating system 200A.

The transparent layer 203 can be part of a software process running on the operating system and can have its own user interface (UI) elements, including a transparent UI superimposed on an underlying user interface and/or visible UI elements that a user is able to interact with.

The virtual driver 204 is configured to emulate drivers 205A and 205B, which interface with hardware devices 206A and 206B, respectively. The virtual driver can receive user input that instructs the virtual driver on which virtual driver to emulate, for example, in the form of a voice command, a selection made on a user interface, and/or a gesture made by the user in front of a coupled web camera. For example, each of the connected hardware devices can operate in a “listening” mode and each of the emulated drivers in the virtual driver 204 can be configured to detect an initialization signal which serves as a signal to the virtual driver to switch to a particular emulation mode. For example, a user stating “start voice commands” can activate the driver corresponding to a microphone to receive a new voice command. Similarly, a user giving a certain gesture can activate the driver corresponding to a web camera to receive gesture input or touch input.

The virtual driver can also be configured to interface with a native driver, such as native driver 205C, which itself communicates with hardware device 206C. In one example, hardware device 206C can be a standard input device, such as a keyboard or a mouse, which is natively supported by the operating system.

The system shown in FIG. 2 allows for implementation of a universal hardware-software interface in which users can utilize any coupled hardware device in a variety of contexts, such as a particular application or the operating system, without requiring the application or operating system to be customized to interface with the hardware device.

For example, hardware device 206A can capture information which is then received by the virtual driver 204 emulating driver 205A. The virtual driver 204 can determine a user input based upon the captured information. For example, if the information is a series of images of a user moving their hand, the virtual driver can determine that the user has performed a gesture.

Based upon an identified context (such as a particular application or the operating system), the user input can be converted into a transparent layer command and transmitted to the transparent layer 203 for execution. The transparent layer command can include native commands in the identified context. For example, if the identified context is application 201A, then the native commands would be in a format that is compatible with application API 201B of application 201A. Execution of the transparent layer command can then be configured to cause execution of one or more native commands in the identified context. This is accomplished by the transparent layer 203 interfacing with each of the APIs of the applications executing on the operating system 200A as well as the operating system API 200B. For example, if the native command is an operating system command, such as a command to launch a new program, then the transparent layer 203 can provide that native command to the operating system API 200B for execution.

As shown in FIG. 2, there is bidirectional communication between all of the components shown. This means, for example, that execution of a transparent layer command in the transparent layer 203 can result in transmission of information to the virtual driver 204 and on to one of the connected hardware devices. For example, after a voice command is recognized as input, converted to a transparent layer command including a native command, and executed by the transparent layer (resulting in execution of the native command in the identified context), a signal can be sent from the transparent layer to a speaker (via the virtual driver) to transmit the sound output “command received.”

Of course, the architecture shown in FIG. 2 is for the purpose of explanation only, and it is understood that the number of applications executing, number and type of connected hardware devices, number of drivers, and emulated drivers can vary.

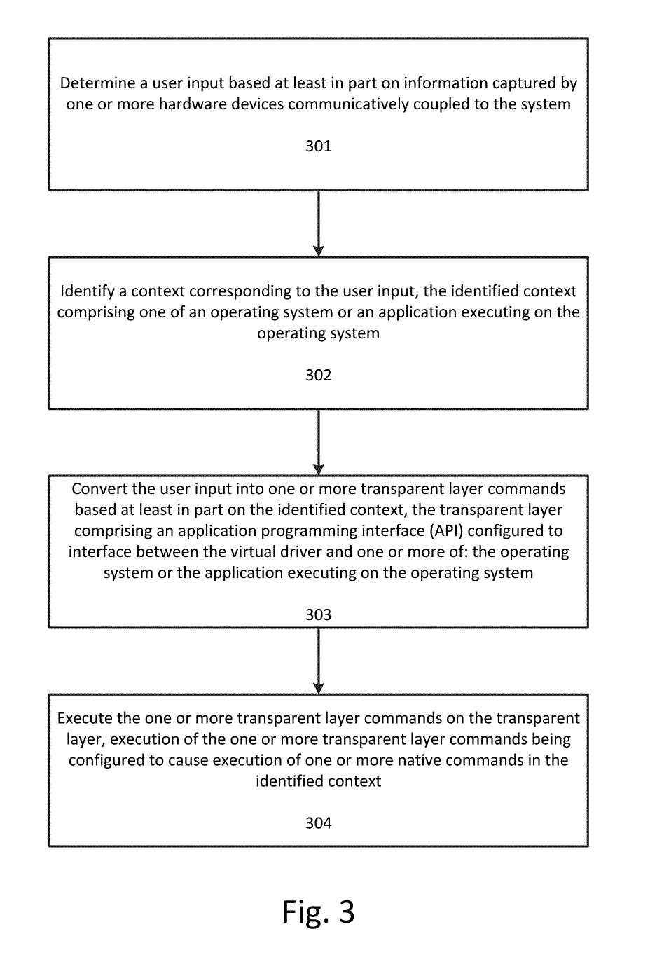

FIG. 3 illustrates a flowchart for implementation of a universal hardware-software interface according to an exemplary embodiment.

At step 301 a user input is determined based at least in part on information captured by one or more hardware devices communicatively coupled to the system. The system, as used herein, can refer to one or more computing devices executing the steps of the method, an apparatus comprising one or more processors and one or more memories executing the steps of the method, or any other computing system.

The user input can be determined by a virtual driver executing on the system. As discussed earlier, virtual driver can be operating in an emulation mode in which it is emulating other hardware drivers and thereby receiving the captured information from a hardware device or can optionally receive the captured information from one or more other hardware drivers which are configured to interface with a particular hardware device.

A variety of hardware devices can be utilized, such as a camera, a video camera, a microphone, a headset having bidirectional communication, a mouse, a touchpad, a trackpad, a controller, a game pad, a joystick, a touch screen, a motion capture device including accelerometers and/or a tilt sensors, a remote, a stylus, or any combination of these devices. Of course, this list of hardware devices is provided by way of example only, and any hardware device which can be utilized to detect voice, image, video, or touch information can be utilized.

The communicative coupling between the hardware devices and the system can take a variety of forms. For example, the hardware device can communicate with the system via a wireless network, Bluetooth protocol, radio frequency, infrared signals, and/or by a physical connection such as a Universal Serial Bus (USB) connection. The communication can also include both wireless and wired communications. For example, a hardware device can include two components, one of which wirelessly (such as over Bluetooth) transmits signals to a second component which itself connects to the system via a wired connection (such as USB). A variety of communication techniques can be utilized in accordance with the system described herein, and these examples are not intended to be limiting.

The information captured by the one or more hardware devices can be any type of information, such as image information including one or more images, frames of a video, sound information, and/or touch information. The captured information can be in any suitable format, such as .wav or .mp3 files for sound information, .jpeg files for images, numerical coordinates for touch information, etc.

The techniques described herein can allow for any display device to function effectively as a “touch” screen device in any context, even if the display device does not include any hardware to detect touch signals or touch-based gestures. This is described in greater detail below and can be accomplished through analysis of images captured by a camera or a video camera.

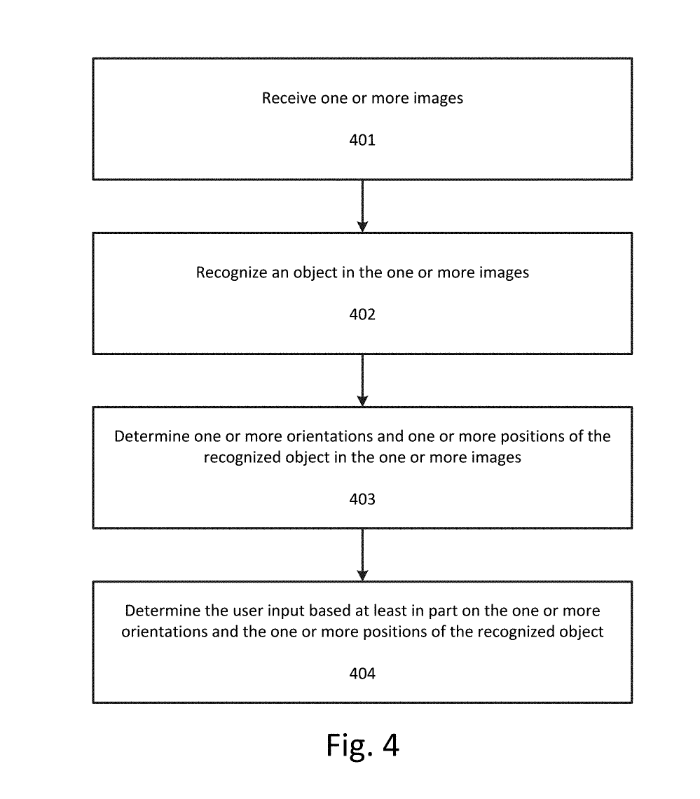

FIG. 4 illustrates a flowchart for determining a user input based at least in part on information captured by one or more hardware devices communicatively coupled to the system when the information captured by the one or more hardware devices comprises one or more images.

At step 401 one or more images are received. These images can be captured by a hardware device such as a camera or video camera and can be received by the virtual driver, as discussed earlier.

At step 402 an object in the one or more images is recognized. The object can be, for example, a hand, finger, or other body part of a user. The object can also be a special purpose device, such as a stylus or pen, or a special-purpose hardware device, such as a motion tracking stylus/remote which is communicatively coupled to the system and which contains accelerometers and/or tilt sensors. The object recognition can be performed by the virtual driver can be based upon earlier training, such as through a calibration routine run using the object.

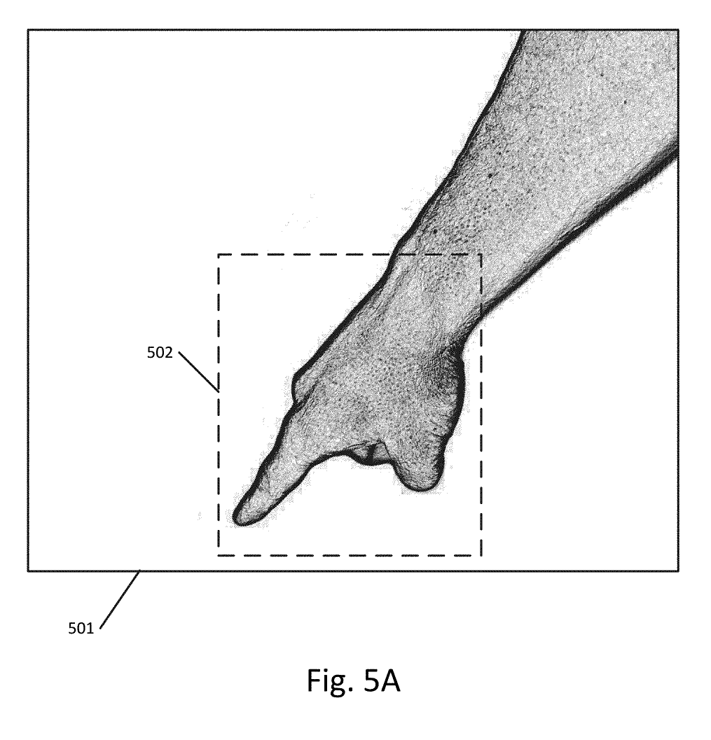

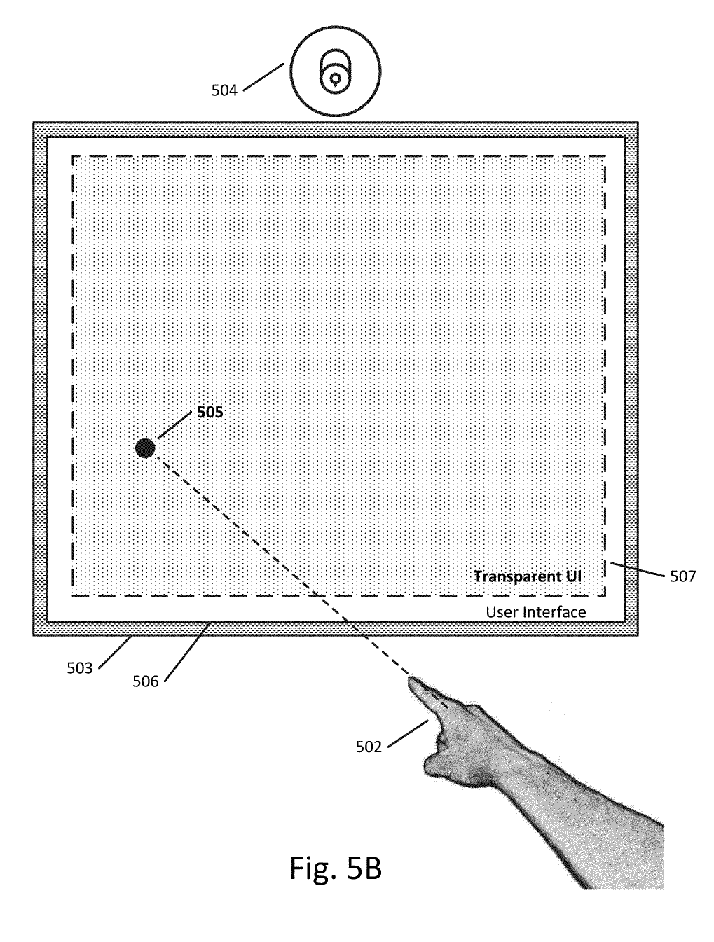

FIG. 5A illustrates an example of object recognition according to an exemplary embodiment. As shown in FIG. 5A, image 501 includes a hand of the user that has been recognized as object 502. The recognition algorithm could of course be configured to recognize a different object, such as a finger.

Returning to FIG. 4, at step 403 one or more orientations and one or more positions of the recognized object are determined. This can be accomplished in a variety of ways. If the object is not a hardware device and is instead a body part, such as a hand or finger, the object can be mapped in a three-dimensional coordinate system using a known location of the camera as a reference point to determine the three dimensional coordinates of the object and the various angles relative to the X, Y, and Z axes. If the object is a hardware device and includes motion tracking hardware such as an accelerometer and/or tilt sensors, then the image information can be used in conjunction with the information indicated by the accelerometer and/or tilt sensors to determine the positions and orientations of the object.

At step 404 the user input is determined based at least in part on the one or more orientations and the one or more positions of the recognized object. This can include determining location coordinates on a transparent user interface (UI) of the transparent layer based at least in part the on the one or more orientations and the one or more positions. The transparent UI is part of the transparent layer and is superimposed on an underlying UI corresponding to the operating system and/or any applications executing on the operating system.

FIG. 5B illustrates an example of this step when the object is a user's finger. As shown in FIG. 5B, display device 503 includes an underlying UI 506 and a transparent UI 507 superimposed over the underlying UI 506. For the purpose of clarity, the transparent UI 507 is shown with dot shading, but it is understood that in practice the transparent UI is a transparent layer that is not visible to the user. Additionally, the transparent UI 507 is shown as slightly smaller than the underlying UI 506 but it is understood that in practice the transparent UI would cover the same screen area as the underlying UI.

As shown in FIG. 5B, the position and orientation information of the object (the user's finger) is used to project a line onto the plane of the display device 503 and determine an intersection point 505. The image information captured by camera 504 and the known position of the display device 503 under the camera can be used to aid in this projection. As shown in FIG. 5B, the user input is determined to be input coordinates at the intersection point 505.

As will be discussed further below, the actual transparent layer command that is generated based on this input can be based upon user settings and/or an identified context. For example, the command can be a touch command indicating that an object at the coordinates of point 505 should be selected and/or opened. The command can also be a pointing command indicating that a pointer (such as a mouse pointer) should be moved to the coordinates of point 505. Additionally, the command can be an edit command which modifies the graphical output at the location (such as to annotate the interface or draw an element).

While FIG. 5B shows the recognized object 502 as being at some distance from the display device 503, a touch input can be detected regardless of the distance. For example, if the user were to physically touch the display device 503, the technique described above would still determine the input coordinates. In that case, the projection line between object 502 and the intersection point would just be shorter.

Of course, touch inputs are not the only type of user input that can be determined from captured images. The step of determining a user input based at least in part on the one or more orientations and the one or more positions of the recognized object can include determining gesture input. In particular, the positions and orientations of a recognized object across multiple images could be analyzed to determine a corresponding gesture, such as a swipe gesture, a pinch gesture, and/or any known or customized gesture. The user can calibrate the virtual driver to recognize custom gestures that are mapped to specific contexts and commands within those contexts. For example, the user can create a custom gesture that is mapped to an operating system context and results in the execution of a native operating system command which launches a particular application.

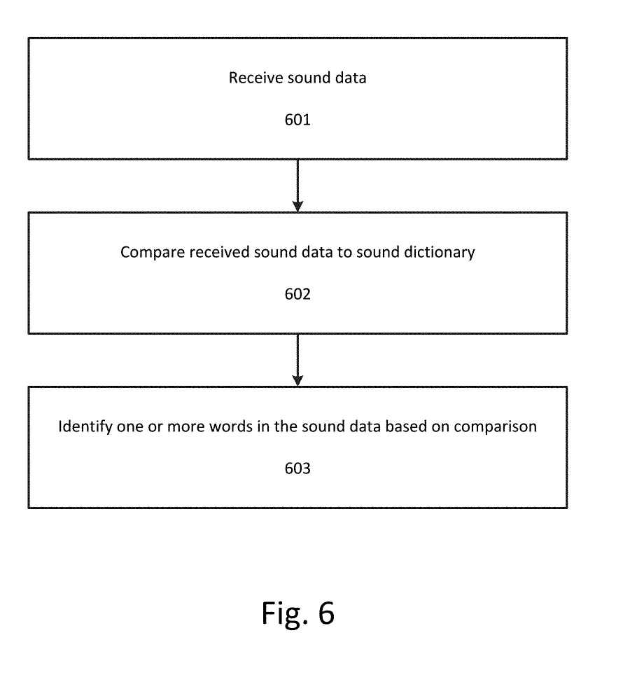

As discussed earlier, the information captured by the one or more hardware devices in step 301 of FIG. 3 can also include sound information captured by a microphone. FIG. 6 illustrates a flowchart for determining a user input based at least in part on information captured by one or more hardware devices communicatively coupled to the system when the captured information is sound information. As discussed below, voice recognition is performed on the sound information to identify one or more words corresponding to the user input.

At step 601 the sound data is received. The sound data can be captured by a hardware device such as a microphone and received by the virtual driver, as discussed above. At step 602 the received sound data can be compared to a sound dictionary. The sound dictionary can include sound signatures of one or more recognized words, such as command words or command modifiers. At step 603 one or more words in the sound data are identified as the user input based on the comparison. The identified one or more words can then be converted into transparent layer commands and passed to the transparent layer.

As discussed earlier, the driver emulated by the virtual driver, the expected type of user input, and the command generated based upon the user input can all be determined based at least in part on one or more settings or prior user inputs.

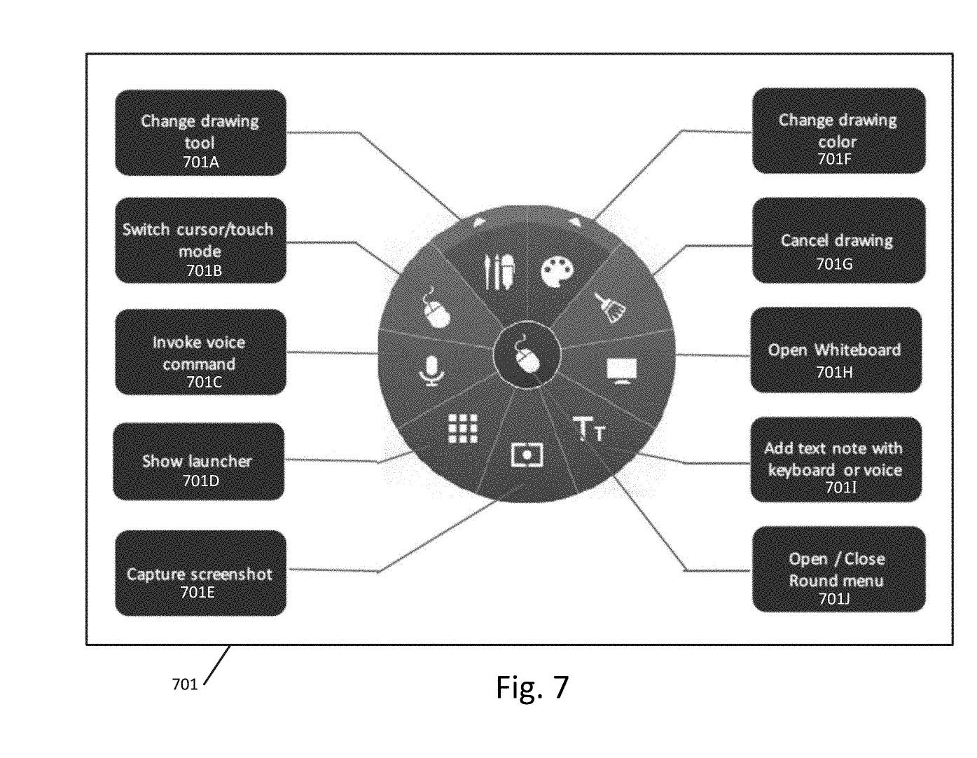

FIG. 7 illustrates a tool interface 701 that can also be part of the transparent layer. Unlike the transparent UI, the tool interface 701 is visible to the user and can be used to select between different options which alter the emulation mode of the virtual driver, the native commands generated based on user input, or perform additional functions.

Button 701A allows a user to select the type of drawing tool used to graphically modify the user interface when the user input is input coordinates (such as coordinates based upon a user touching the screening with their hand or a stylus/remote). The various drawing tools can include different brushes, colors, pens, highlighters, etc. These tools can result in graphical alterations of varying styles, thicknesses, colors, etc.

Button 701B allows the user to switch between selection, pointing, or drawing modes when input coordinates are received as user input. In a selection mode, the input coordinates can be processed as a “touch” and result in selection or opening of an object at the input coordinates. In pointing mode the coordinates can be processed as a pointer (such as a mouse pointer) position, effectively allowing the user to emulate a mouse. In drawing mode, the coordinates can be processed as a location at which to alter the graphical output of the user interface to present the appearance of drawing or writing on the user interface. The nature of the alteration can depend on a selected drawing tool, as discussed with reference to button 701A. Button 701B can also alert the virtual driver to expect image input and/or motion input (if a motion tracking device is used) and to emulate the appropriate drivers accordingly.

Button 701C alerts the virtual driver to expect a voice command. This can cause the virtual driver to emulate drivers corresponding to a coupled microphone to receive voice input and to parse the voice input as described with respect to FIG. 6.

Button 701D opens a launcher application which can be part of the transparent layer and can be used to launch applications within the operating system or to launch specific commands within an application. Launcher can also be used to customize options in the transparent layer, such as custom voice commands, custom gestures, custom native commands for applications associated with user input and/or to calibrate hardware devices and user input (such as voice calibration, motion capture device calibration, and/or object recognition calibration).

Button 701E can be used to capture a screenshot of the user interface and to export the screenshot as an image. This can be used in conjunction with the drawing mode of button 701B and the drawing tools of 701A. After a user has marked up a particular user interface, the marked up version can be exported as an image.

Button 701F also allows for graphical editing and can be used to change the color of a drawing or aspects of a drawing that the user is creating on the user interface. Similar to the draw mode of button 701B, this button alters the nature of a graphical alteration at input coordinates.

Button 701G cancels a drawing on the user interface. Selection of this button can remove all graphical markings on the user interface and reset the underlying UI to the state it was in prior to the user creating a drawing.

Button 701H can be used to launch a whiteboard application that allows a user to create a drawing or write using draw mode on a virtual whiteboard.

Button 701I can be used to add textual notes to objects, such as objects shown in the operating system UI or an application UI. The textual notes can be interpreted from voice signals or typed by the user using a keyboard.

Button 701J can be used to open or close the tool interface 701. When closed, the tool interface can be minimized or removed entirely from the underlying user interface.

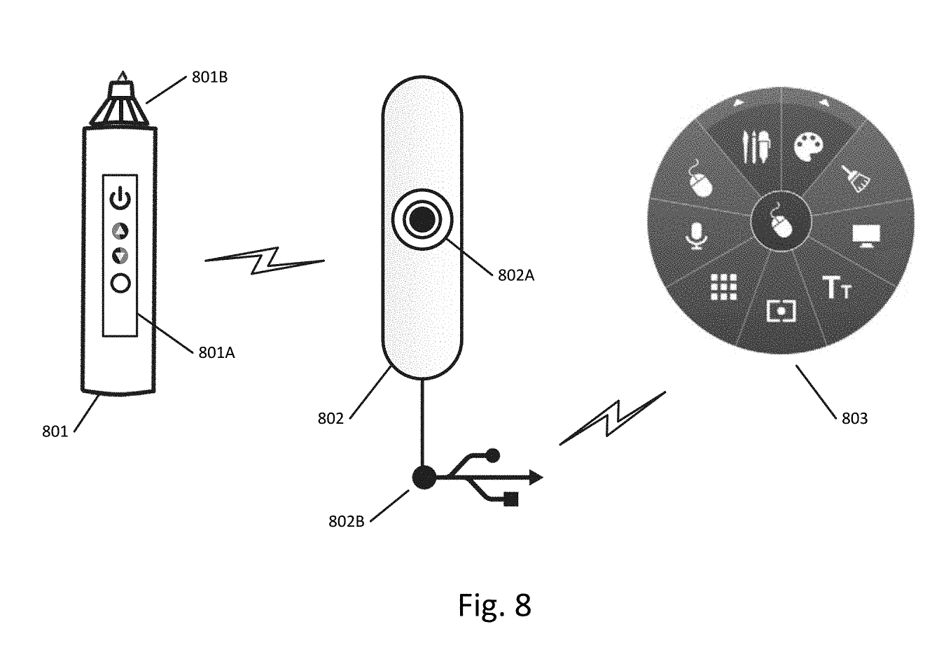

As discussed earlier, a stylus or remote hardware device can be used with the present system, in conjunction with other hardware devices, such as a camera or video camera. FIG. 8 illustrates an example of a stylus 801 that can be used with the system. The stylus 801 can communicate with a hardware receiver 802, such as over Bluetooth. The hardware receiver can connect to computer system, such as via USB 802B and the signals from the stylus passed to computer system via hardware receiver can be used to control and interact with menu 803, which is similar to the tool interface shown in FIG. 7.

As shown in FIG. 8, the stylus 801 can include physical buttons 801A. These physical buttons 801 can be used to power the stylus on, navigate the menu 803, and make selections. Additionally, the stylus 801 can include a distinctive tip 801B which is captured in images by a camera and recognized by the virtual driver. This can allow the stylus 801 to be used for drawing and editing when in draw mode. The stylus 801 can also include motion tracking hardware, such an accelerometer and/or tilt sensors to aid in position detection when the stylus is used to provide input coordinates or gestures. Additionally, the hardware receiver 802 can include a calibration button 802A, which when depressed, can launch a calibration utility in the user interface. This allows for calibration of the stylus.

Returning to FIG. 3, at step 302 a context is identified corresponding to the user input. The identified context comprises one of an operating system or an application executing on the operating system.

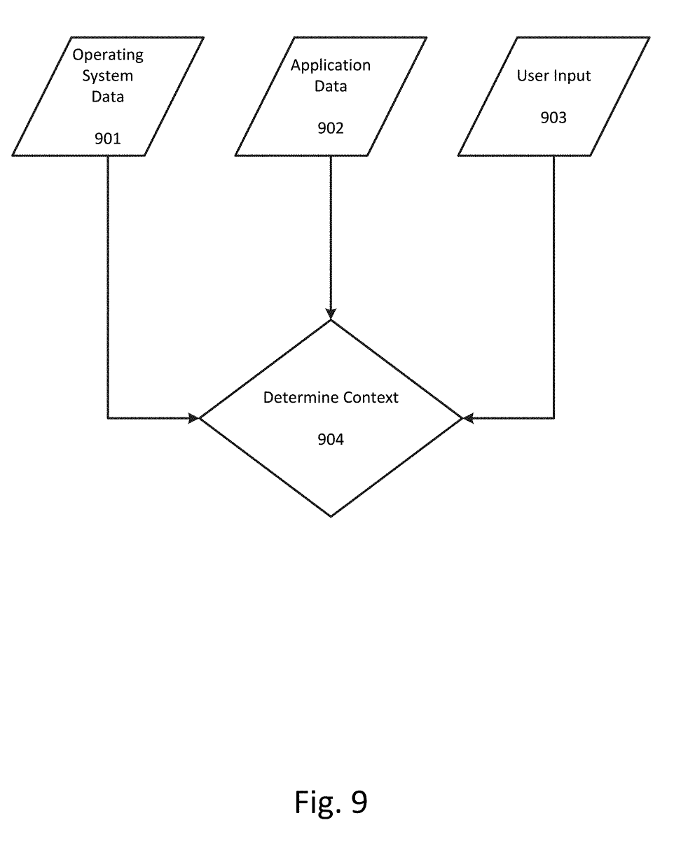

FIG. 9 illustrates a flowchart for identifying a context corresponding to the user input according to an exemplary embodiment. As shown in FIG. 9, operating system data 901, application data 902, and user input data 903 can all be used to determine a context 904.

Operating system data 901 can include, for example, information regarding an active window in the operating system. For example, if the active window is a calculator window, then the context can be determined to be a calculator application. Similarly, if the active window is a Microsoft Word window, then the context can be determined to be the Microsoft Word application. On the other hand, if the active window is a file folder, then the active context can be determined to be the operating system. Operating system data can also include additional information such as which applications are currently executing, a last launched application, and any other operating system information that can be used to determine context.

Application data 902 can include, for example, information about one or more applications that are executing and/or information mapping particular applications to certain types of user input. For example, a first application may be mapped to voice input so that whenever a voice command is received, the context is automatically determined to be the first application. In another example, a particular gesture can be associated with a second application, so that when that gesture is received as input, the second application is launched or closed or some action within the second application is performed.

User input 903 can also be used to determine the context in a variety of ways. As discussed above, certain types of user input can be mapped to certain applications. In the above example, voice input is associated with a context of a first application. Additionally, the attributes of the user input can also be used to determine a context. Gestures or motions can be mapped to applications or to the operating system. Specific words in voice commands can also be mapped to applications or to the operating system. Input coordinates can also be used to determine a context. For example, a window in the user interface at the position of the input coordinates can be determined and an application corresponding to that window can be determined as the context.

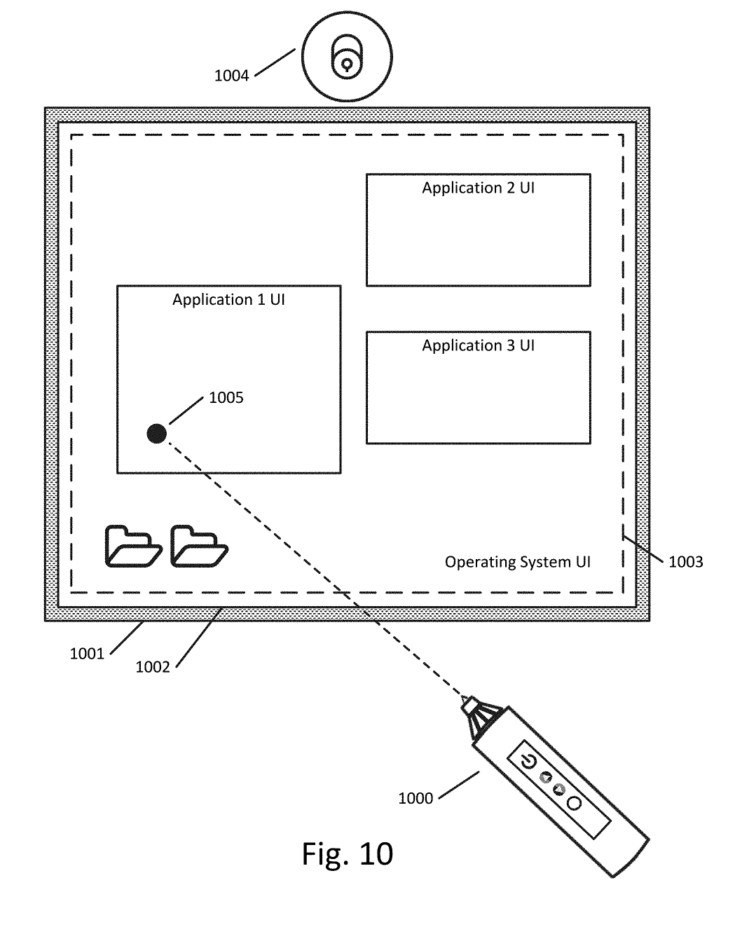

FIG. 10 illustrates an example of using the input coordinates to determine a context. As shown in FIG. 10, the display device 1001 is displaying a user interface 1002. Also shown is a camera 1004 and transparent layer 1003 superimposed over underlying user interface 1003. A user utilizes a stylus 1000 to point to location 1005 in user interface 1002. Since location 1005 lies within an application window corresponding to Application 1, then Application 1 can be determined to be the context for the user input, as opposed to Application 2, Application 3, or the Operating System.

Returning to FIG. 3, at step 303 the user input is converted into one or more transparent layer commands based at least in part on the identified context. As discussed earlier, the transparent layer comprises an application programming interface (API) configured to interface between the virtual driver and the operating system and/or an application executing on the operating system.

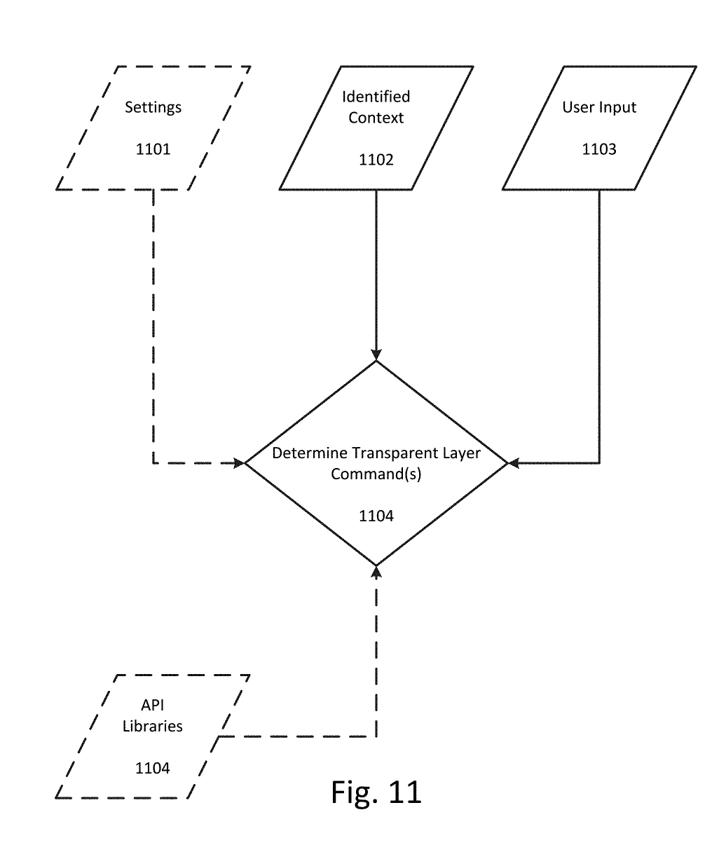

FIG. 11 illustrates a flowchart for converting user input into transparent layer commands. As shown at step 1104 of FIG. 11, the transparent layer command can be determined based at least in part on the identified context 1102 and the user input 1103. The transparent layer command can include one or more native commands configured to execute in one or more corresponding contexts. The transparent layer command can also include response outputs to be transmitted to the virtual driver and on to hardware device(s).

The identified context 1102 can be used to determine which transparent layer command should be mapped to the user input. For example, if the identified context is “operating system,” then a swipe gesture input can be mapped to a transparent layer command that results in the user interface scrolling through currently open windows within the operating system (by minimizing one open window and maximize a next open window). Alternatively, if the identified context is “web browser application,” then the same swipe gesture input can be mapped to a transparent layer command that results in a web page being scrolled.

The user input 1103 also determines the transparent layer command since user inputs are specifically mapped to certain native commands within one or more contexts and these native commands are part of the transparent layer command. For example, a voice command “Open email” can be mapped to a specific operating system native command to launch the email application Outlook. When voice input is received that includes the recognized words “Open email,” this results in a transparent layer command being determined which includes the native command to launch Outlook.

As shown in FIG. 11, transparent layer commands can also be determined based upon one or more user settings 1101 and API libraries 1104. API libraries 1104 can be used to lookup native commands corresponding to an identified context and particular user input. In the example of the swipe gesture and a web browser application context, the API library corresponding to the web browser application can be queried for the appropriate API calls to cause scrolling of a web page. Alternatively, the API libraries 1104 can be omitted and native commands can be mapped directed to a particular user inputs and identified contexts.

In the situation where the user input is determined to be input coordinates the transparent layer command is determined based at least in part on the input location coordinates and the identified context. In this case, the transparent layer command can include at least one native command in the identified context, the at least one native command being configured to perform an action at the corresponding location coordinates in the underlying UI.

When there is more than one possible action mapped to a particular context and user input, settings 1101 can be used to determine the corresponding transparent layer command. For example, button 701B of FIG. 7 allows user to select between selection, pointing, or draw modes when input coordinates are received as user input. This setting can be used to determine the transparent layer command, and by extension, which native command is performed and which action is performed. In this case, the possible native commands can include a selection command configured to select an object associated with the corresponding location coordinates in the underlying UI, a pointer command configured to move a pointer to the corresponding location coordinates in the underlying UI, and a graphical command configured to alter the display output at the corresponding location coordinates in the underlying UI.

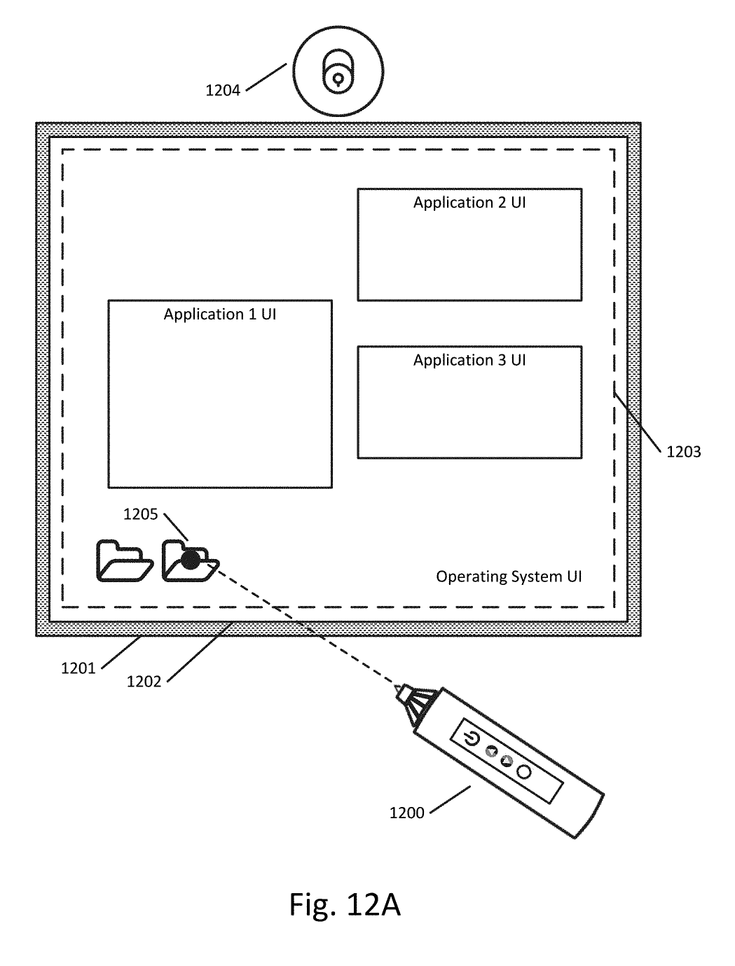

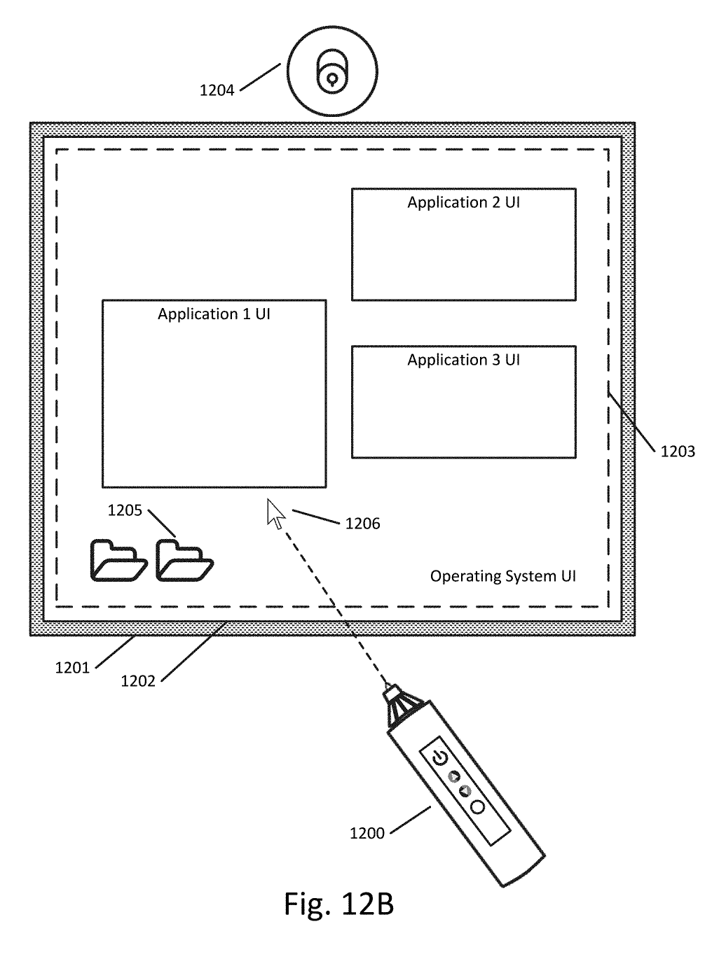

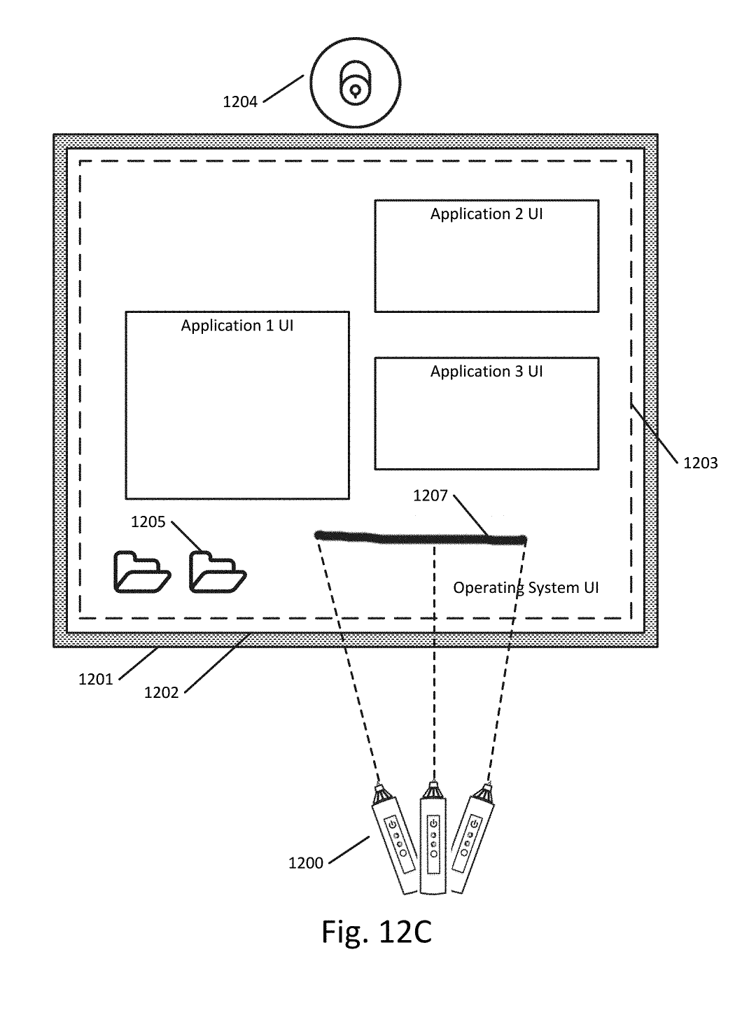

FIG. 12A illustrates an example of receiving input coordinates when the selection mode is toggled. As shown in FIG. 12A, the user has pointed stylus 1200 at operating system UI 1202 (having superimposed transparent UI 1203) on display device 1201. Similar to earlier examples, camera 1204 can be used to determine the position and orientation information for stylus 1200 and the input coordinates. Since the selection mode is toggled and the stylus 1200 is pointed at folder 1205 within the operating system UI 1202, the determined transparent layer command can include a native operating system command to select an object associated with the input coordinates (which in this case is folder 1205). In another example, if a window was located at the input coordinates, this would result in selection of the entire window.

FIG. 12B illustrates an example of receiving input coordinates when the pointing mode is toggled. In this case, the determined transparent layer command can include a native operating system command to move mouse pointer 1206 to the location of the input coordinates.

FIG. 12C illustrates an example of receiving input coordinates when the drawing mode is toggled and the user has swept stylus 1200 over multiple input coordinates. In this case, the determined transparent layer command can include a native operating system command to alter the display output at the locations of each of the input coordinates, resulting in the user drawing line 1207 on the user interface 1202. The modified graphical output produced in drawing mode can be stored as part of the transparent layer 1203, for example, as metadata related to a path of input coordinates. The user can then select an option to export the altered display output as an image.

In the situation wherein the user input is identified as a gesture, converting the user input into one or more transparent layer commands based at least in part on the identified context can include determining a transparent layer command based at least in part on the identified gesture and the identified context. The transparent layer command can include at least one native command in the identified context, the at least one native command being configured to perform an action associated with the identified gesture in the identified context. An example of this is discussed above with respect to a swipe gesture and a web browser application context that results in a native command configured to perform a scrolling action in the web browser.

In the situation wherein the user input is identified as one or more words (such as by using voice recognition), converting the user input into one or more transparent layer commands based at least in part on the identified can include determining a transparent layer command based at least in part on the identified one or more words and the identified context. The transparent layer command can include at least one native command in the identified context, the at least one native command being configured to perform an action associated with the identified one or more words in the identified context.

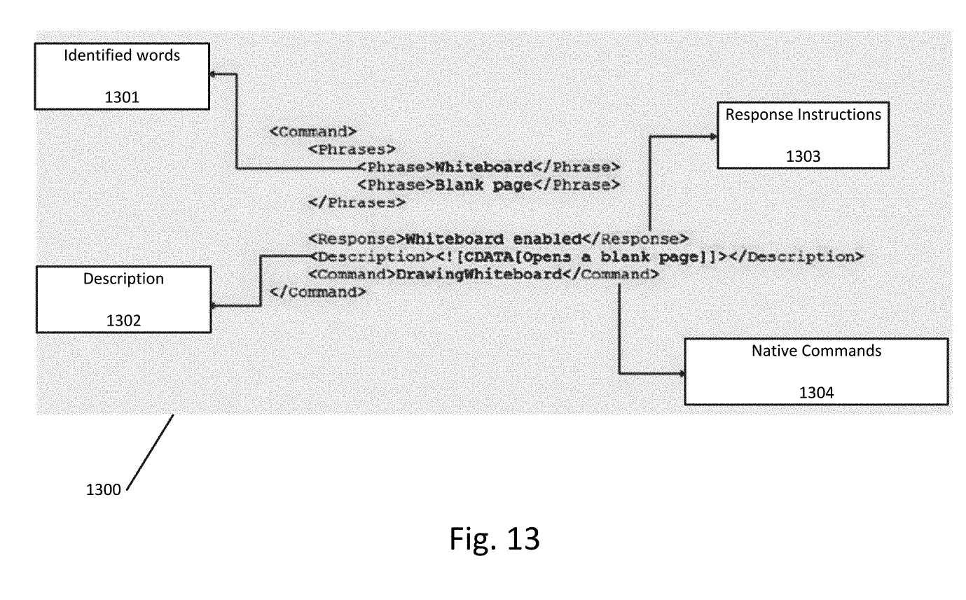

FIG. 13 illustrates an example of a transparent layer command 1300 determined based on one or more words identified in input voice data. The identified words 1301 include one of the phrases “whiteboard” or “blank page.” Transparent layer command 1300 also includes a description 1302 of the command, and response instructions 1303 which are output instructions sent by the transparent layer to the virtual driver and to a hardware output device upon execution of the transparent layer command. Additionally, transparent layer command 1300 includes the actual native command 1304 used to call the white board function.

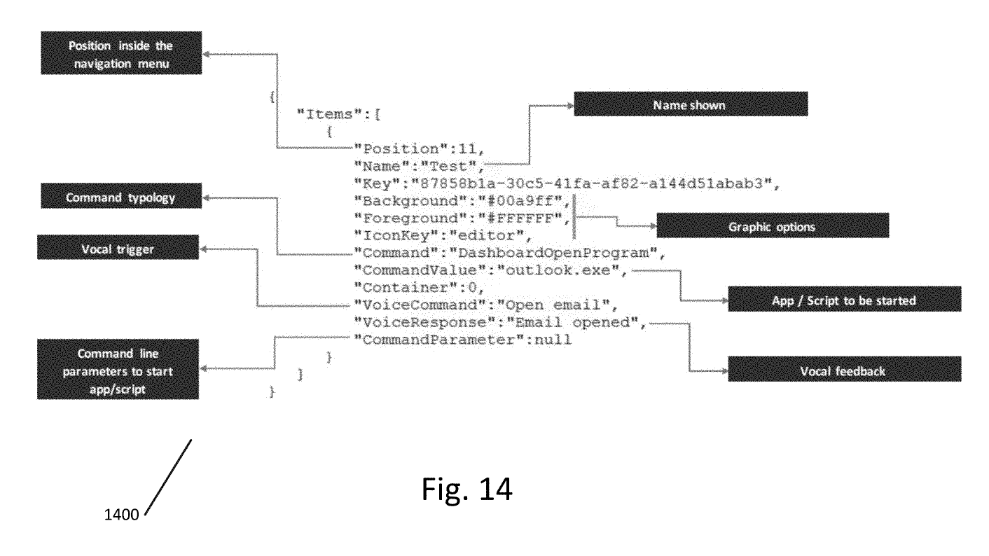

FIG. 14 illustrates another example of a transparent layer command 1400 determined based on one or more words identified in input voice data according to an exemplary embodiment. In this example, the one or more words are “open email.” As shown in FIG. 14, the transparent layer command 1400 includes the native command “outlook.exe,” which is an instruction to run a specific executable file that launches the outlook application. Transparent layer command 1400 also includes a voice response “email opened” which will be output in response to receiving the voice command.

Returning to FIG. 3, at step 304 the one or more transparent layer commands are executed on the transparent layer. Execution of the one or more transparent layer commands is configured to cause execution of one or more native commands in the identified context.

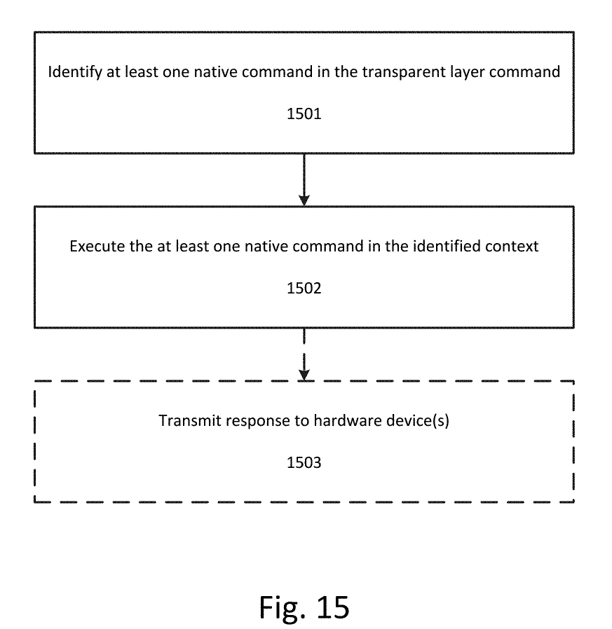

FIG. 15 illustrates a flowchart for executing the one or more transparent layer commands on the transparent layer according to an exemplary embodiment. At step 1501 at least one native command in the transparent layer command is identified. The native command can be, for example, designated as a native command within the structure of the transparent layer command, allowing for identification.

At step 1502 the at least one native command is executed in the identified context. This step can include passing the at least one native command to the identified context via an API identified for that context and executing the native command within the identified context. For example, if the identified context is the operating system, then the native command can be passed to the operating system for execution via the operating system API. Additionally, if the identified context is an application, then the native command can be passed to application for execution via the application API.

Optionally, at step 1503, a response can be transmitted to hardware device(s). As discussed earlier, this response can be routed from the transparent layer to the virtual driver and on to the hardware device.

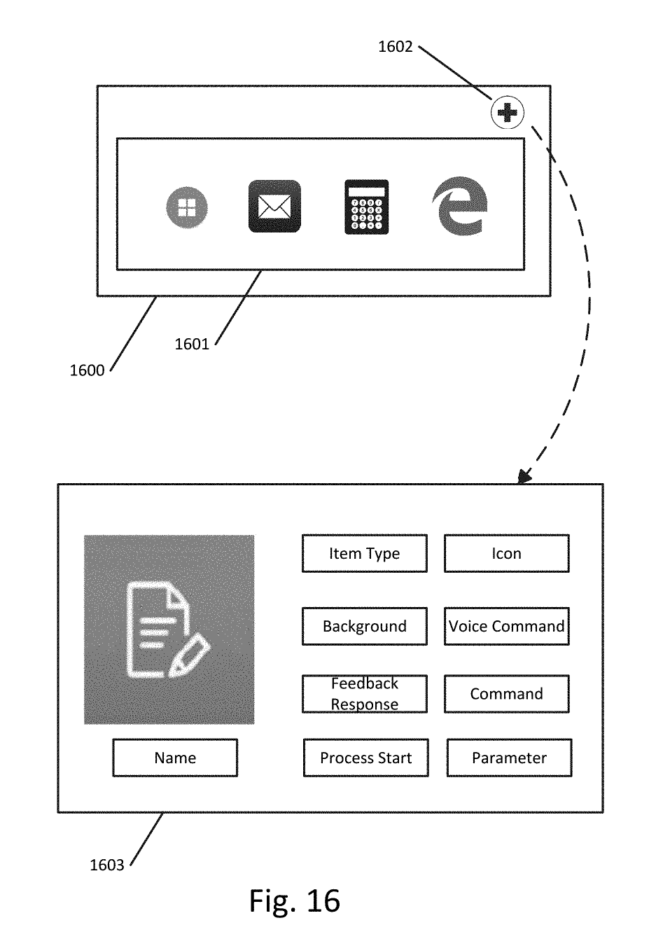

FIGS. 16-19 illustrate additional features of the system disclosed herein. FIG. 16 illustrates an example interface for adding new commands corresponding to user input according to an exemplary embodiment. The dashboard in interface 1600 includes icons of applications 1601 which have already been added and can be launched using predetermined user inputs and hardware devices (e.g., voice commands). The dashboard can also show other commands that are application-specific and that are mapped to certain user inputs. Selection of addition button 1602 opens the add command menu 1603. This menu allows users to select between the following options: Item type: Fixed Item to add on bottom bar menu/Normal Item to add in a drag menu; Icon: Select the image icon; Background: Select the background icon color; Color: Select the icon color; Name: Set the new item name; Voice command: Set the voice activation command to open the new application; Feedback response: Set the application voice response feedback; Command: Select application type or custom command type to launch (e.g., launch application command, perform action within application command, close application command, etc.); Process Start: if launching a new process or application, the name of the process or application; and Parameter: any parameters to pass into the new process or application.

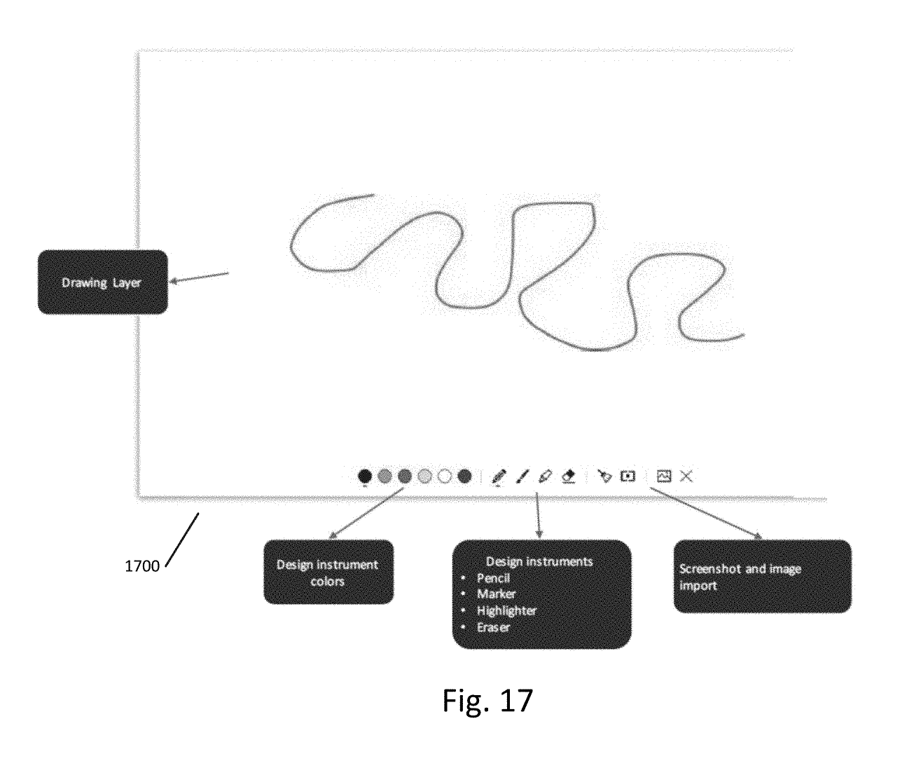

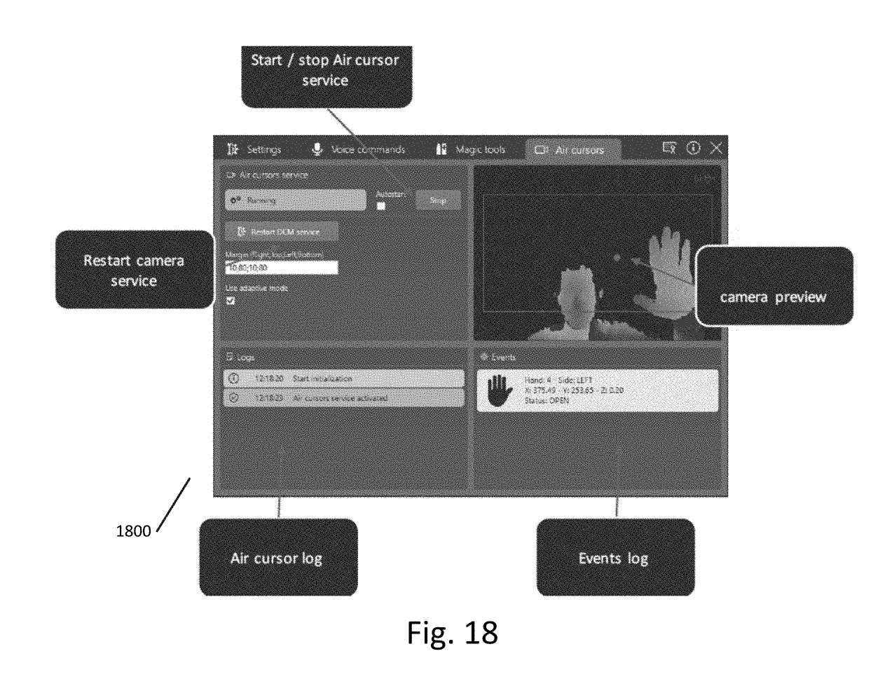

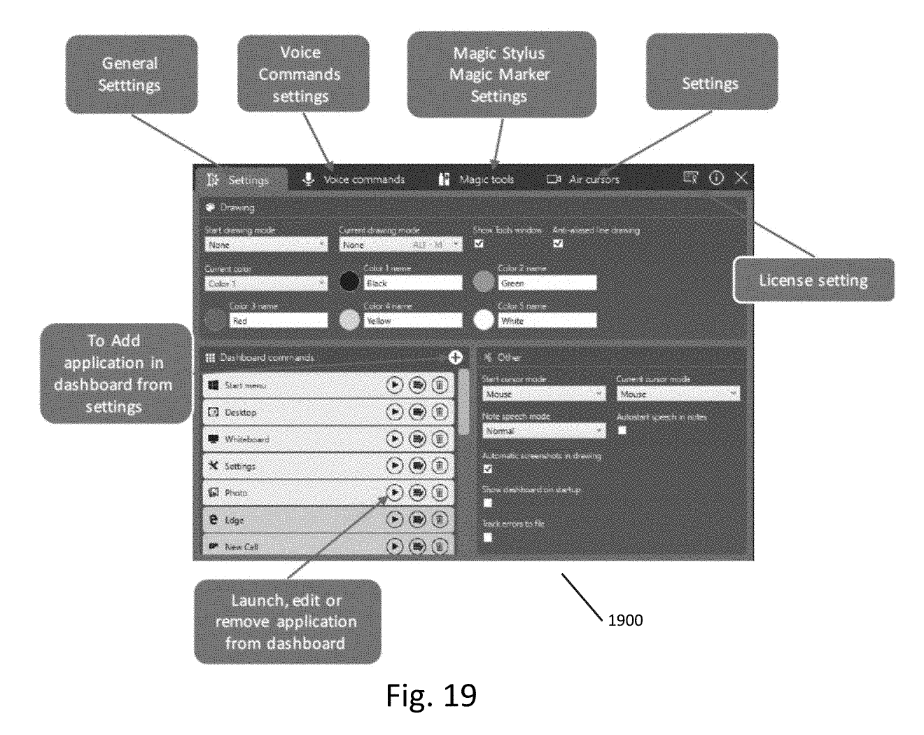

FIG. 17 illustrates various components and options of the drawing interface 1700 and draw mode according to an exemplary embodiment. FIG. 18 illustrates a calibration and settings interface 1800 for a video camera hardware device that is used to recognize objects and allows for a user to provide input using touch and gestures. FIG. 19 illustrates a general settings interface 1900 which allows a user to customize various aspects of the interface, toggle input modes, and make other changes. As shown in interface 1900, a user can also access a settings page to calibrate and adjust settings for a hardware stylus (referred to as the “Magic Stylus”).

The system disclosed herein can be implemented on multiple networked computing devices and used an aid in conducting networked collaboration sessions. For example, the whiteboard functionality described earlier can be a shared whiteboard between multiple users on multiple computing devices.

Networked collaboration spaces are frequently used for project management and software development to coordinate activities among team members, organize and prioritize tasks, and brainstorm new ideas. For example, Scrum is an agile framework for managing work and projects in which developers or other participants collaborate in teams to solve particular problems through real-time (in person or online) exchange of information and ideas. The Scrum framework is frequently implemented using a Scrum board, in which users continuously post physical or digital post-it notes containing ideas, topics, or other contributions throughout a brainstorming session.

One of the problems with existing whiteboards and other shared collaboration spaces, such as networked Scrum boards, is that the information that is conveyed through the digital post-it notes is limited to textual content, without any contextual information regarding a contribution (such as an idea, a task, etc.) from a participant and without any supporting information that may make it easier and more efficient to share ideas in a networked space, particularly when time is a valuable resource. Additionally, since Scrum sessions can sometimes involve various teams having different responsibilities, the inability of digital post-it notes to selectively restrict access to the contained ideas can introduce additional vulnerabilities in the form of exposure of potentially confidential or sensitive information to collaborators on different teams or having different security privileges.

There is currently no efficient way to package collaboration contribution data from collaborators with related content data and access control data in a format that is efficiently transportable over a network onto multiple networked computing devices within a collaboration sessions and in a format that simultaneously includes functionality for embedding or use in networked project management sessions, such as Scrum sessions.

In addition to the earlier described methods and systems for implementation of a universal hardware-software interface, Applicant has additionally discovered methods, apparatuses and computer-readable media that allow for propagating enriched note data objects over a web socket connection in a networked collaboration workspace and that solve the above-mentioned problems.

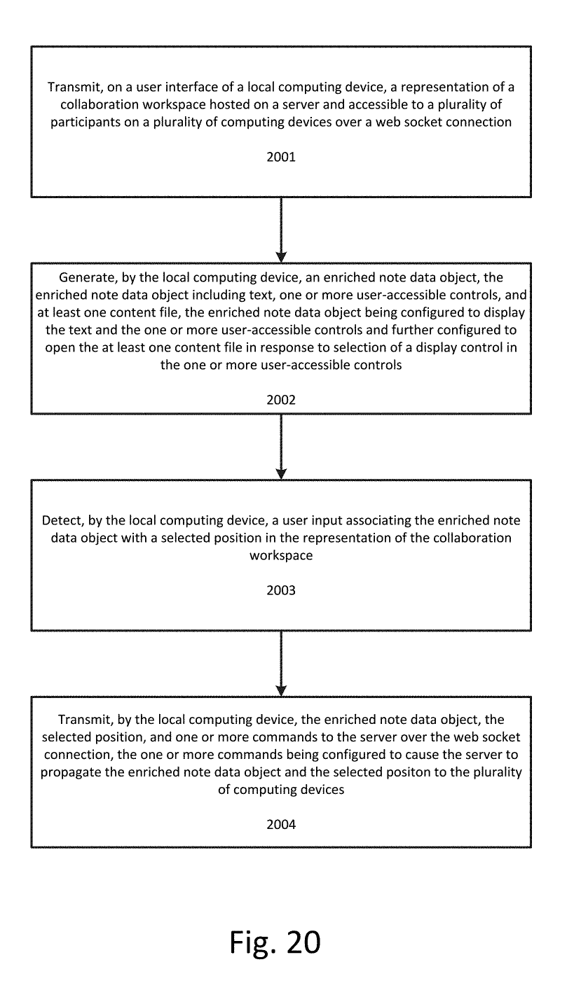

FIG. 20 illustrates a flowchart for propagating enriched note data objects over a web socket connection in a networked collaboration workspace according to an exemplary embodiment. All of the steps shown in FIG. 20 can be performed on a local computing device, such as a client device connected to a server, and do not require multiple computing devices. The disclosed process can also be implemented by multiple devices connected to a server or by a computing device that acts both a local computing device and a server hosting a networked collaboration session for one or more other computing devices.

At step 2001 a representation of a collaboration workspace hosted on a server is transmitted on a user interface of a local computing device. The collaboration workspace is accessible to a plurality of participants on a plurality of computing devices over a web socket connection, including a local participant at the local computing device and one or more remote participants at remote computing devices. As used herein, remote computing devices and remote participants refers to computing devices and participants other than the local participant and the local computing device. Remote computing devices are separated from the local device by a network, such as a wide area network (WAN).

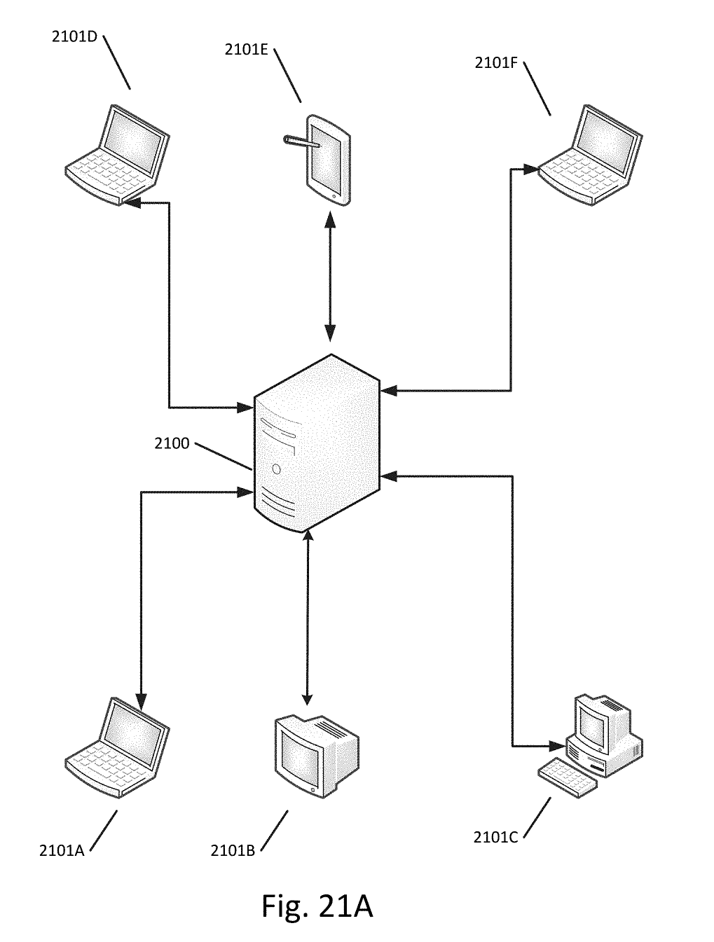

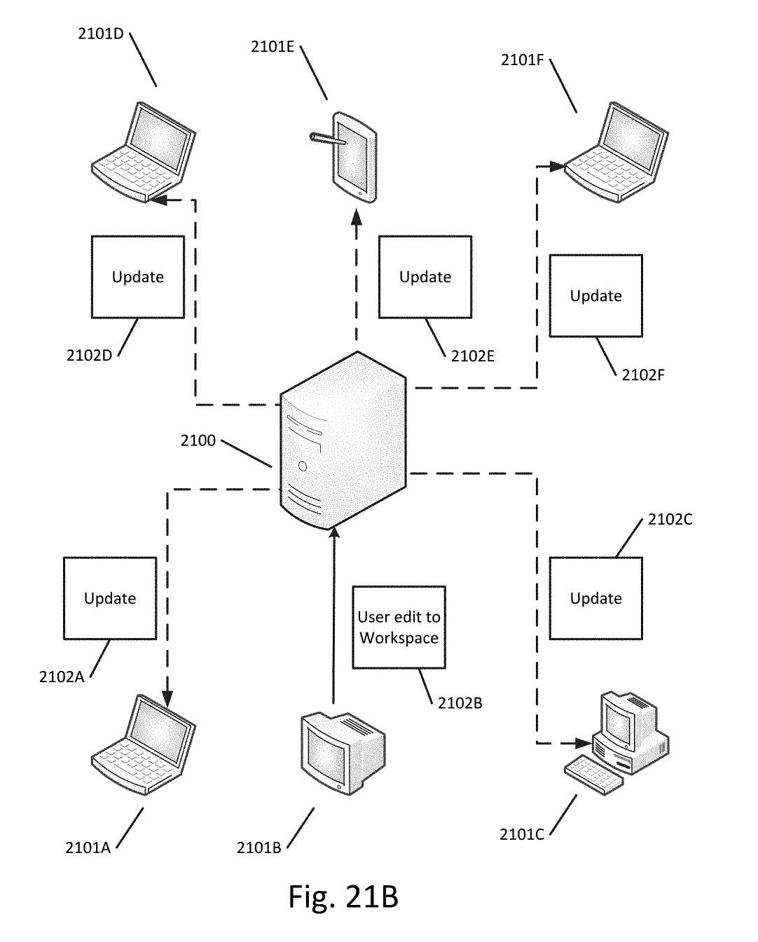

FIG. 21A illustrates the network architecture used to host and transmit the collaboration workspace according to an exemplary embodiment. As shown in FIG. 21A, server 2100 is connected to computing devices 2101A-2101F. The server 2100 and computing devices 2101A-2101F can be connected via a network connection, such as web socket connection, that allows for bi-directional communication between the computing devices 2101A-2101F (clients) and the server 2100. As shown in FIG. 21A, the computing devices can be any type of computing device, such as a laptop, desktop, smartphone, or other mobile device. Additionally, while the server 2100 is shown as a separate entity, it is understood that any one of the computing devices 2101A-2101F can also act as a server for the other computing devices, meaning that computing devices performs the functions of a server in hosting the collaboration session even though it is a participant in the collaboration session itself.

The collaboration workspace can be, for example, a digital whiteboard configured to propagate any edits from any participants in the plurality of participants to other participants over the web socket connection. FIG. 21B illustrates the process for propagating edits to the collaboration workspace within the network according to an exemplary embodiment. As shown in FIG. 21B, if a user at computing device 2101B makes an edit or an alteration to the collaboration workspace, this edit or alteration 2102B is sent to the server 2100, where it is used to update the hosted version of the workspace. The edit or alteration is then propagated as updates 2102A, 2102C, 2102D, 2102E, and 2102F by the server 2100 to the other connected computing devices 2101A, 2101C, 2101D, 2101E, and 2101F.

Each representation of the collaboration workspace can be a version of the collaboration workspace that is customized to a local participant. For example, as discussed above, each representation of the collaboration workspace can include one or more remote participant objects corresponding to one or more remote computing devices connected to the server.

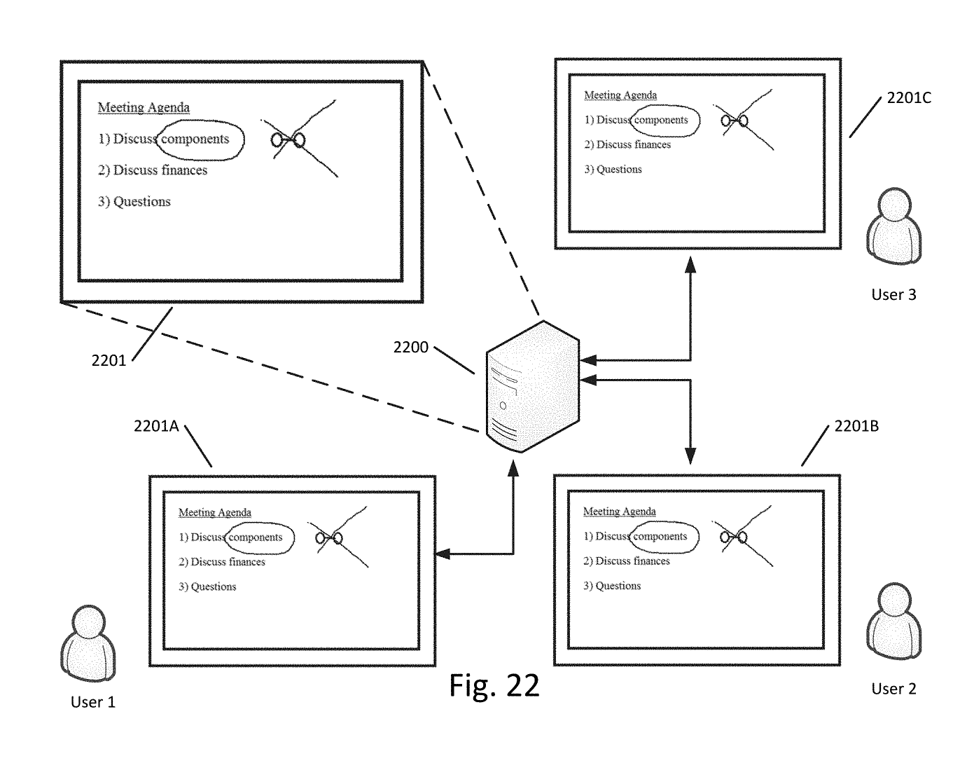

FIG. 22 illustrates multiple representations of a collaboration workspace according to an exemplary embodiment. As shown in FIG. 22, server 2200 hosts collaboration workspace 2201. The version of the collaboration workspace hosted on the server is propagated to the connected devices, as discussed earlier. FIG. 22 also illustrates the representations of the collaboration workspace for three connected users, User 1, User 2, and User 3. Each representation can optionally be customized to the local participant (to the local computing device at each location).

Returning to FIG. 20, at step 2002 an enriched note data object is generated by the local computing device. The enriched note data object is created in response to inputs from the user (such as through a user interface) and includes text as selected or input by the user and configured to be displayed, one or more user-accessible controls configured to be displayed, and at least one content file that is selected by the user. The enriched note data object is configured to display the text and the one or more user-accessible controls within an enriched note user interface element that is defined by the enriched note data object and is further configured to open the at least one content file in response to selection of a display control in the one or more user-accessible controls. For example, the enriched note data object can include embedded scripts or software configured to display the note user interface element and the user-accessible controls. The enriched note data object can, for example, store a link or pointer to an address of a content file in association with or as part of a display control script that is part of the enriched note data object and store the actual content item in a separate portion of the enriched note data object. In this case, the link or pointer can reference the address of the content item within the separate portion of the enriched note data object. The content item can be any type of content item, such a video file, an image file, an audio file, a document, a spreadsheet, a web page.

An enriched note is a specialized user interface element that is the visual component of an enriched note data object. The enriched note is a content-coupled or content-linked note in that the underlying data structure (the enriched note data object) links the display text (the note) with a corresponding content item within the enriched note data object that has been selected by a user. This linked content stored in the enriched note data object is then accessible through the enriched note via the user-accessible control of the enriched note. The enriched note (and the corresponding underlying data structure of the enriched note data object) therefore acts as a dynamic digitized Post-It® note in that it links in the memory of a computing device certain display text with an underlying content item in a way that is accessible, movable, and shareable over a networked collaboration session having many participants. The enriched note (and the underlying enriched note data object) offers even greater functionality in that it can be “pinned” to any type of content (not just documents) and integrates dynamic access controls and other functionality. As will be discussed in greater detail below, the enriched note data object solves the existing problems in networked collaboration sessions because it offers the functionality of linking contributions from participants to notes that are “affixed” to certain virtual locations while at the same permitting each participant to independent interact with the enriched notes and access related linked content.

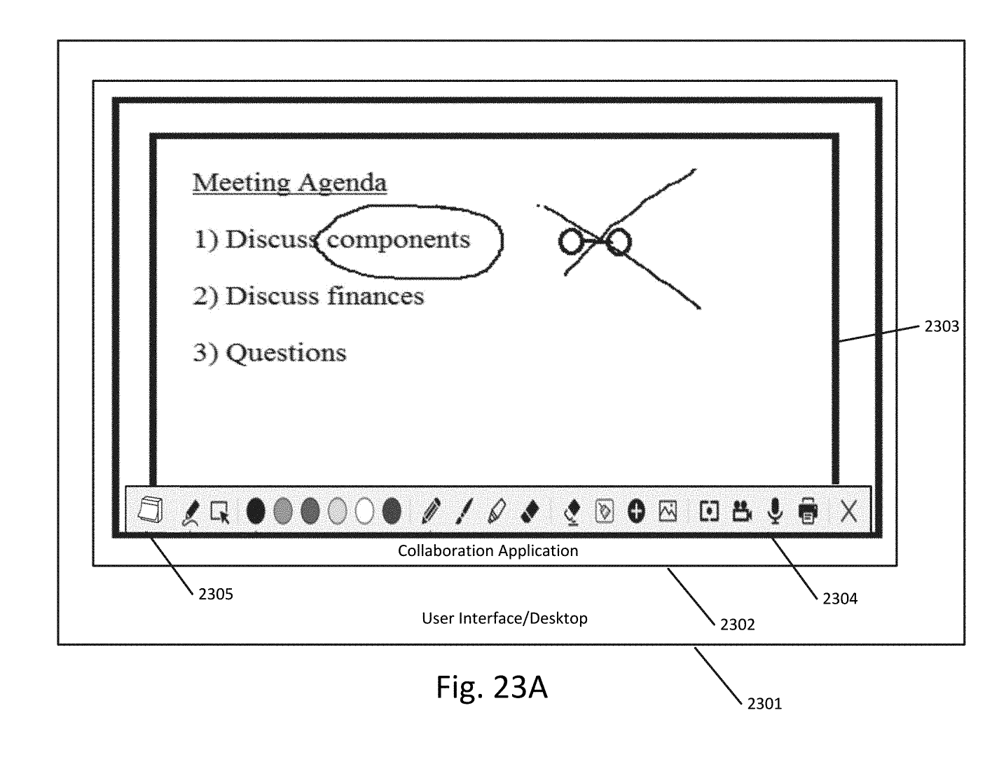

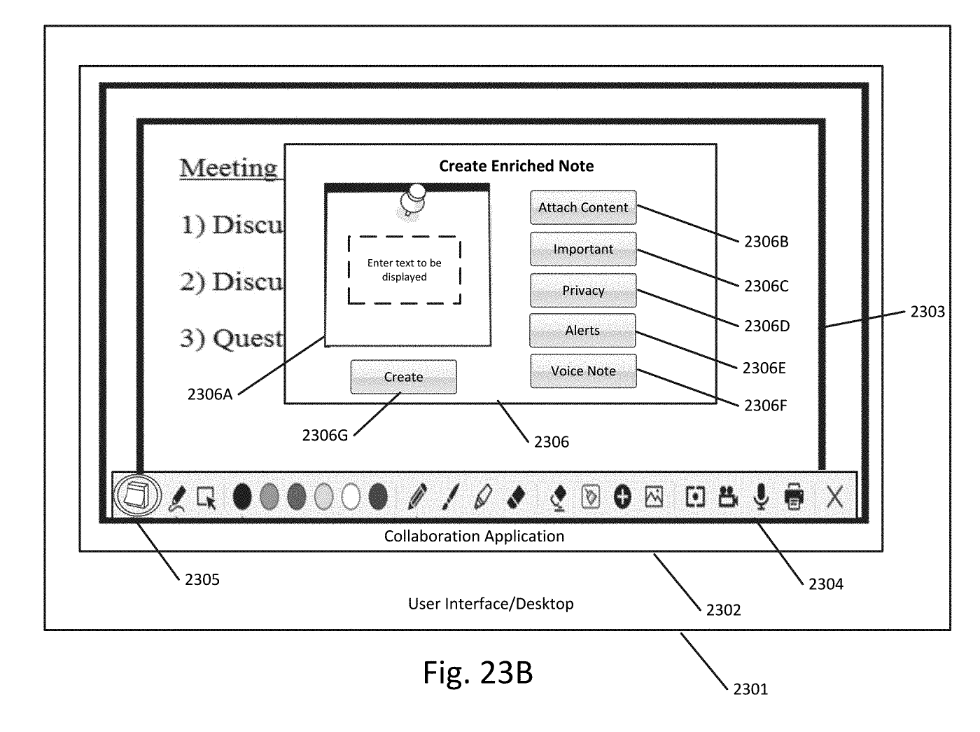

FIGS. 23A-23B illustrate a process used to generate the enriched note data object within a networked collaboration workspace according to an exemplary embodiment.

FIG. 23A illustrates an example of the user interface (desktop) of a local computing device prior to receiving a request to generate the enriched note data object. As shown in FIG. 23A, user interface 2301 includes a collaboration application 2302 that locally displays the representation of the collaboration workspace 2303 hosted on the server.

Collaboration application 2302 can include the representation of the collaboration workspace 2303 that contains all edits and contributions by the local participant and any other participants, as well as a toolbar 2304. The toolbar 2304 can include various editing tools, settings, commands, and options for interacting with or configuring the representation of the collaboration workspace. For example, the toolbar 2304 can include editing tools to draw on the representation of the collaboration workspace 2303, with edits being propagated over the web socket connection to the server and other connected computed devices.

Toolbar 2304 additionally includes an enriched note button 2305 that, when selected, causes the local computing device to display a prompt or an interface that allows the selecting user to generate an enriched note and specify the attributes and characteristics of the enriched note. A user can therefore begin the process of generating an enriched note by selecting the screen sharing button 2305. Note that, as used herein, the “enriched note” refers to a user interface element corresponding to the “enriched note data object.” As will be discussed in greater detail below, the “enriched note data object” includes data, such as automated scripts, content files or links to content files, privacy settings, and other configuration parameters that are not always displayed as part of the “enriched note.”

FIG. 23B illustrates an example of the user interface (desktop) 2301 of the local computing device after the user has selected the enriched note button 2305 of the toolbar 2304. As shown in FIG. 23B, selection of the enriched note button 2305 causes the local computing device to display an enriched note creation interface 2306.

The enriched note creation interface 2306 includes multiple input areas, including a text entry area 2306A which allows the user to type a message that will be displayed on the face of the enriched note. Alternatively, the user can select from one of a number of predefined messages. For example, a list of predetermined messages can be displayed in response to the user selecting the text entry area 2306 and the user can then select one of the predetermined messages.

The enriched note creation interface 2306 additionally includes an attach content button 2603B. Upon selection of the attach content button 2306B, an interface can be displayed allowing a user to select a content file from a local or network folder to be included in the enriched note data object and accessible from the enriched note. Additionally, selection of the attach content button 2306B can also result in the display of a content input interface, such as a sketching tool or other input interface that allows the user to directly create the content. In this case, the created content can be automatically saved as a file in folder and the created file can be associated with enriched note. As discussed earlier, the content item can be any type of content item, such as a video file, an image file, an audio file, a document, a spreadsheet, and/or a web page. The user can also specify the content by including a link, such as a web page link, in which case the relevant content can be downloaded from the web page and attached as a web page document (such as an html file). Alternatively, given the prevalence of web browsers, the web page link can itself be classified as the attached content, in which case a user receiving the enriched note would simply have to click on the link to access the content from the relevant web source within their local browser.

The enriched note creation interface 2306 additionally includes an important button 2603C. Upon selection of the important button 2306C, an importance flag associated with the enriched note can be set to true. This results in the enriched note be displayed with an important indicator (such as a graphic or message) that alerts viewers that the enriched note is considered to be urgent or important.

The enriched note creation interface 2306 additionally includes a privacy button 2603D. Upon selection of the privacy button 2306D, an interface can be displayed allowing a user to input privacy settings. The privacy settings can allow the user to set up access controls for the content portion of the enriched note, such as a password, an authentication check, and/or a list of approved participants. When a list of approved participants is utilized, the IP addresses associated with each of the approved participants can be retrieved from the server over the web socket connection and linked to the access controls, so that the content portion of the enriched note can only be accessed from IP addresses associated with approved users. Alternatively, the creator of the enriched note can specify some identifier of each approved participant and those participants can enter the appropriate identifier to gain access to the content. Many variations of privacy controls are possible and these examples are not intended to be limiting.

The enriched note creation interface 2306 additionally includes an alerts button 2603E. Upon selection of the alerts button 2306E, an interface can be displayed allowing a user to configure one or more alerts associated with the enriched note. The alerts can be notifications, such as pop-up windows, communications, such as emails, or other notifications, such as calendar reminders. The user can selected a time and date associated with each of the alerts, as well as an alert message. For local alerts, such as pop-up windows or calendar notifications, any receiver of the enriched note will therefore have any alerts associated with the enriched note activated on their local computing device at the appropriate time and date. For communications alerts, a communication from the creator of the enriched note to the receivers of the enriched note can be triggered at the selected time and date. For example, a reminder alert can remind recipients of the enriched note to review by a certain deadline.

The enriched note creation interface 2306 additionally includes a voice note button 2603F. Selection of the voice note button 2603F results in a prompt or an interface asking the creator to record a voice to be included in enriched note data object and accessible from the enriched note. Optionally, the voice note button 2603F can be integrated into the attach content button 2603 so that a user can record voice notes and attach other type of content by selecting the attach content button 2603.

Buttons 2306B-2306F are provided by way of example only, and the enriched note creation interface 2306 can include other user-configurable options. For example, the enriched note creation interface 2306 can include options that allow a user to configure a size, shape, color, or pattern of the enriched note.

Once the creator has completed configuring the enriched note, setting any flags, setting privacy controls, attaching content, and/or recording a voice note, they can create the enriched note data object by selecting the create button 2306G. Creation of the enriched note data object includes the integration of all of the settings and content specified by the creator and can be performed in a variety of ways. For example, the enriched note data object can be configured as data container including automated scripts corresponding to selected settings and links to the specified content along with content files themselves. The enriched note data object can also be a predefined template data object having numerous flags that are set based on the creator's selections and including predefined links that are populated with the address of selected content files.

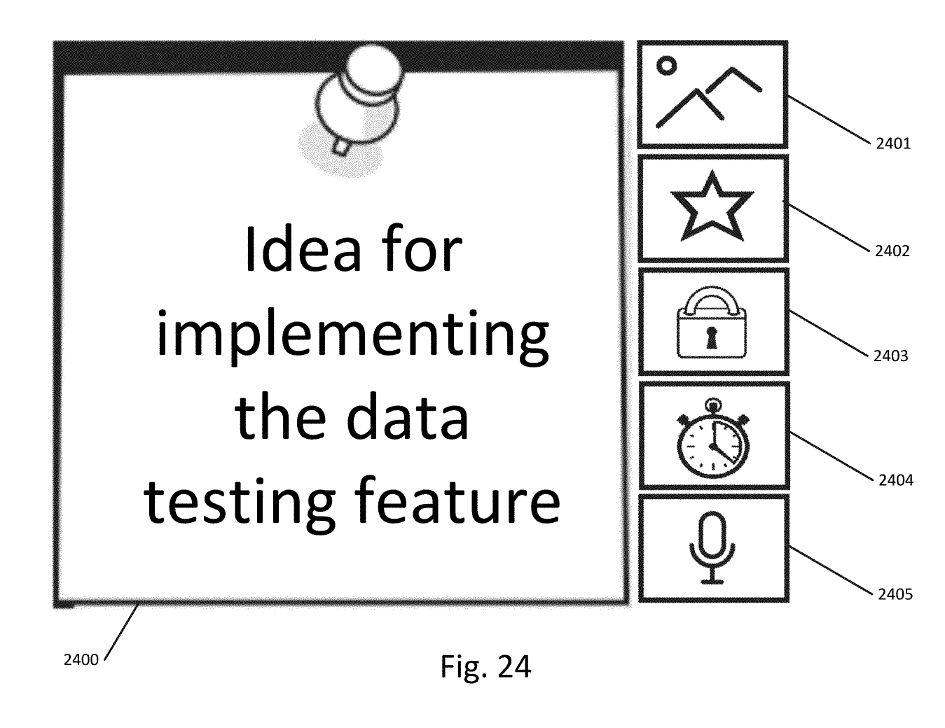

FIG. 24 illustrates a generated enriched note 2400 according to an exemplary embodiment. As shown in FIG. 24, the enriched note 2400 displays the text “Idea for implementing the data testing feature” and includes user-accessible controls 2401-2405. Each of the user-accessible controls is linked to a functionality or setting of the enriched note, as defined by the enriched note data object.

The enriched note 2400 includes a display control 2401 that indicates there is additional content associated with the enriched note. Selection of display control 2401 is configured to cause the enriched note 2400 to display the content item that is associated with the enriched note 2400. In response to selection of the display control 2401, the enriched note data object is configured to detect an application associated with the at least one content file and open the at least one content file by initializing the application associated with the at least one content file in a content display area of the enriched note and loading the at least one content file in the initialized application. The content display area can be adjacent to a primary display area that is configured to display the text and the one or more user-accessible controls 2401-2405. The user is then able to browse, scroll, or otherwise interact with the opened content.

The icon used for the display control 2401 can itself be determined based upon the type of content file that is associated or linked with the enriched note. As shown in FIG. 24, the display control 2401 icon corresponds to an image file, indicating that the linked content is an image. Other types of icons can be automatically determined and utilized instead of user-accessible control based on an analysis of the type of content file linked by the creator. For example, different icons can be used for document files, portable document format (PDF) files, video files, or web browser links. In the event that the creator has not associated any content items with the enriched note, the enriched note data object can be configured to omit the display control 2401 icon from the enriched note 2400.

Also shown in FIG. 24 is an importance indicator 2402 icon. The enriched note data object is configured to display the importance indicator icon (shown as a star icon) when the creator of the enriched note has flagged the note as being important. The importance of the enriched note can be set as either a flag (either important or not important) or can be set as an importance value from a plurality of different importance values (e.g., low, medium, high). The importance indicator 2402 icon can indicate the importance value associated with the enriched note. The importance indicator 2402 icon can display an image or have a visual attribute that indicates the importance level. For example, the importance indicator 2402 icon can be color-coded so that the most important enriched notes have a red importance indicator 2402 icon whereas the least importance enriched notes have a green importance indicator 2402 icon. In the event that the creator has not flagged the enriched note as important, the importance indicator 2402 icon can optionally be omitted.

Selection of the alert control 2402 can display any alerts or notifications associated with the enriched note 2400. For example, selection of the alert control can indicate a time and date associated with a particular notification. When the enriched note includes alerts, the alert can be triggered by the operating system of the device that receives the enriched note. For example, the alert can be triggered as a push notification that is transmitted to the client or as a calendar event that is added to the calendar of the client. The calendar event can be transmitted as a notification alert and then selected by the user to be added to the calendar. Alternatively, if the user provides permissions for access to the calendar application on their device, then calendar events can be added automatically.

FIG. 24 additionally illustrates a privacy control 2403 icon (shown as a lock). The enriched note data object is configured to display the privacy control 2403 when there are privacy or access controls associated with the enriched note. The enriched content note data object is configured to determine whether there are any privacy or access control mechanisms associated with the enriched note data object in response to selection of either the display control 2401 or the privacy control 2403. If there are any kind of privacy or access control mechanisms associated with the enriched note data object, then the enriched content note data object is configured to cause an authentication check (in accordance with the privacy or access control mechanisms) to be performed prior to opening or otherwise providing access to any associated content file.

The authentication check can be, for example, requiring a password, requiring and validating user credentials, verifying that an internet protocol (IP) address associated with the user is on an approved list, requiring the user to agree to certain terms, etc. For example, when there are privacy controls associated with the enriched note and a user selects the display control 2401 icon, an authentication check can be performed prior to the associated content being displayed to the user. Optionally, the user can trigger an authentication check prior to attempting to open the associated content just by selecting the privacy control 2403 icon. The enriched note data object is configured to deny access to the associated content file if an authentication check is failed.

Also shown in FIG. 24 is an alert control 2404. The enriched note data object is configured to display the alert control (shown as a clock icon) when there are alerts associated with the enriched note. Selection of the alert control 2404 can display any alerts or notifications associated with the enriched note 2400 at a time and date associated with the alert. For example, selection of the alert control can indicate a time and date associated with a particular notification. When the enriched note includes alerts, the alert can be triggered by the operating system of the device that receives the enriched note. For example, the alert can be triggered as a push notification that is transmitted to the client or as a calendar event that is added to the calendar of the client. The calendar event can be transmitted as a notification alert and then selected by the user to be added to the calendar. Alternatively, if the user provides permissions for access to the calendar application on their device, then calendar events can be added automatically.

The enriched note 2400 can also include a voice note indicator 2405 icon. The enriched note is configured to display the voice note indicator 2405 icon when the creator has included a voice note in the enriched note data object. When voice note indicator 2405 icon is displayed, selection of the voice note indicator 2405 icon results in the opening of an audio playback application in an adjacent window or interface and the loading of the corresponding voice note in the audio playback application. The user can then listen to or navigate through the voice note.

Returning to FIG. 20, at step 2003 a user input associating the enriched note data object with a selected position in the representation of the collaboration workspace is detected by the local computing device. For example, once the enriched note is created (such as is shown in FIG. 24), a user can drag and drop or otherwise position the enriched note within the collaboration workspace in order to “pin” the enriched note to that position within the collaboration workspace.

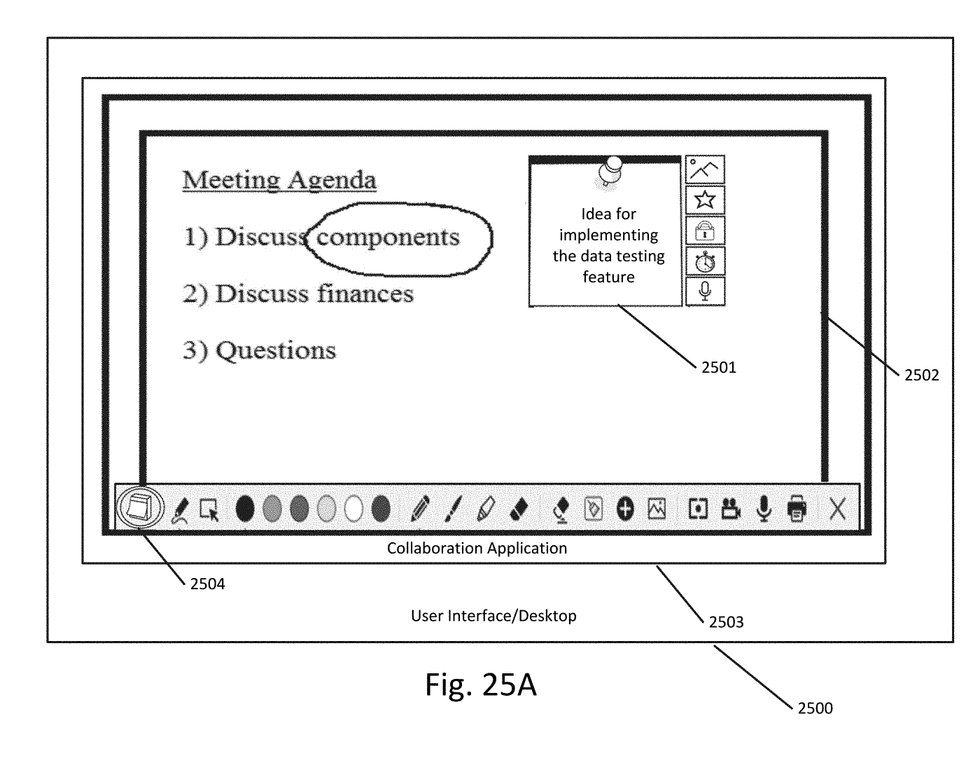

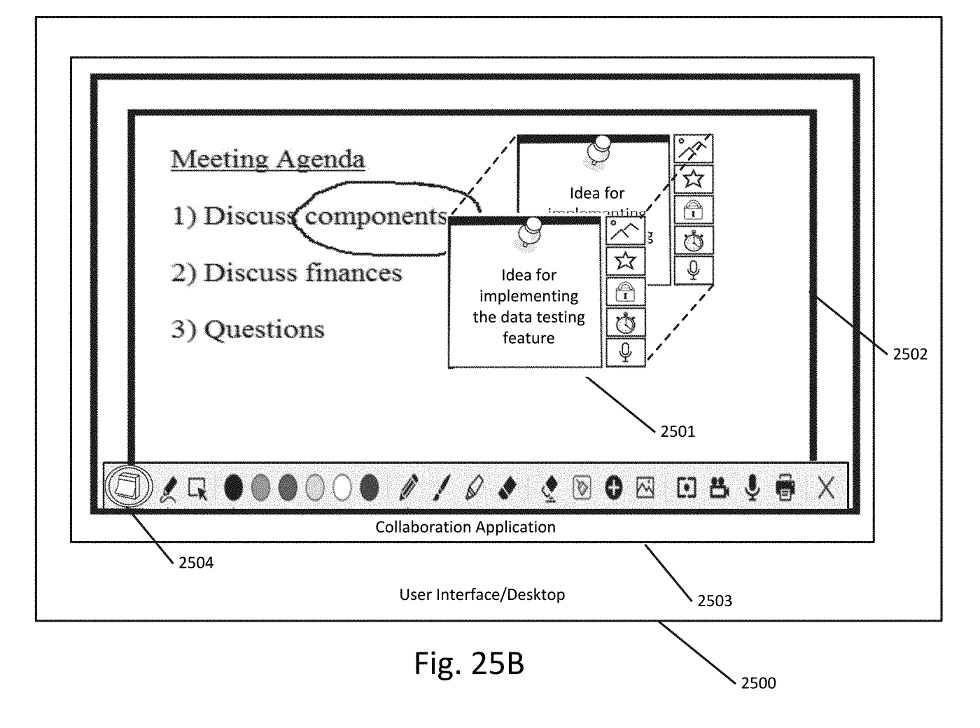

FIGS. 25A-25B illustrate an example of detecting a user input associating the enriched note data object with a selected position in the representation of the collaboration workspace according to an exemplary embodiment.

As shown in FIG. 25A, a creator has completed the process for creating the enriched note and the resulting enriched note 2501 is initially displayed within collaboration workspace 2502 of collaboration application 2503 in the user interface 2500. At this point, a position for the enriched note 2501 has not yet been selected.

FIG. 25B illustrates the process of selecting a position for the enriched note 2501. As shown in FIG. 25B, the user can drag the enriched note 2501 to the desired position within the collaboration workspace 2502. Once the user is satisfies with the position, the position can be detected either by the user “dropping” the enriched note 2501 (such as by depressing the pointing device) and/or by the user selecting some user interface element (such as enriched note icon 2504) to indicate that they are satisfied with the position. The position within the collaboration workspace 2502 is then detected and stored in memory in association with the enriched note. The position can be detected by the collaboration application 2503 itself, an operating system, or by a transparent layer as discussed earlier in this application.

As an alternative to detecting a user input associating the enriched note data object with a selected position after creation of the enriched note, a user input can be detected prior to creation of the enriched note data object in which the user first specifies a position within the collaboration workspace. For example, referring to FIG. 25A, the user can drag the enriched note icon 2504 to a desired position within the collaboration workspace 2502 in order to initiate the enriched note generation process, as described with respect to FIGS. 23A-23B. Once the enriched note is generated, it can automatically be “pinned” to the earlier detected position which the user specified by dragging the enriched note icon 2504.

Returning to FIG. 20, at step 2004 the enriched note data object, the selected position, and one or more commands are transmitted by the local computing device to the server over the web socket connection. The one or more commands are configured to cause the server to propagate the enriched note data object and the selected position to all computing devices connected to the server for the collaboration session. The one or more commands are further configured to cause the server to instruct each of the connected computing devices (i.e., the local version of the collaboration application on each computing device and/or the transparent layer on each computing device) to insert an enriched note corresponding to the enriched note data object (including all associated content and settings) at the selected position. For example, the commands sent from the local computing device to the server can cause the server to send additional commands to each connected device that instruct the connected computing devices to insert or instantiate a copy of the enriched note within their local representations of the collaboration workspace at the selected position. Upon receiving the enriched note data object and the selected position, each computing device connected to the collaboration session can be configured to insert the enriched note data object at the selected position within a local representation of the collaboration workspace. Each copy of the enriched note on each connected computing device includes the settings (such as privacy controls, alerts, etc.) and links to content (associated content items, voice recordings, etc.) as the original enriched note, all of which are contained within the enriched note data object received by each connected computing device.

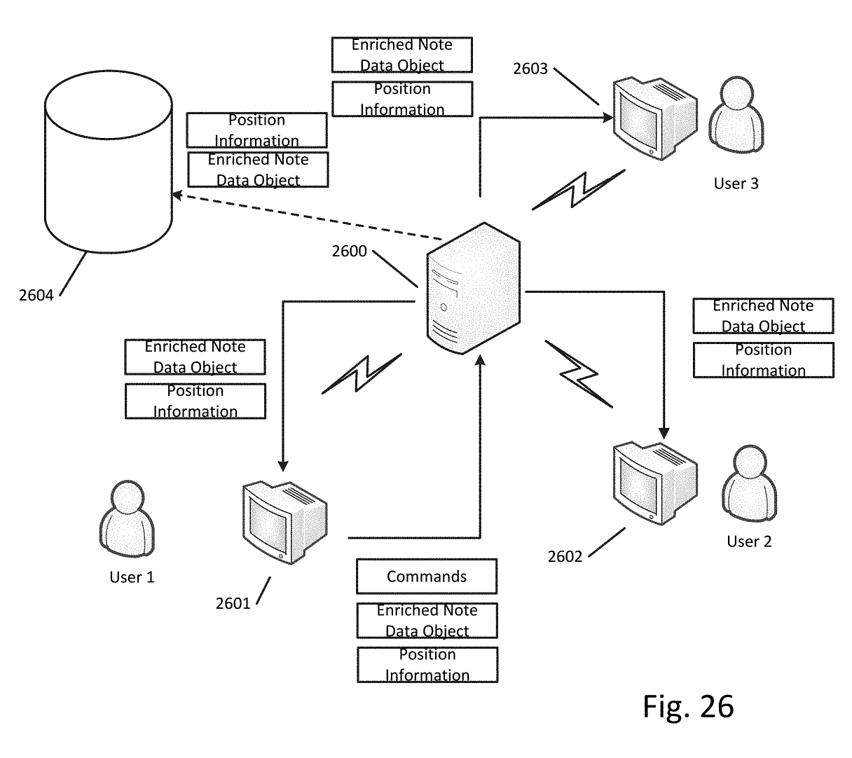

FIG. 26 illustrates the process for propagating the enriched note data object according to an exemplary embodiment. As shown in FIG. 26, after User 1 at computing device 2601 creates the enriched note data object and selects an associated position for the enriched note data object, the enriched note data object is sent to the server 2600 along with position information (detected in step 103 of FIG. 20) that indicates where the enriched note data object should be inserted within the collaboration workspace and commands that instruct the server 2600 to propagate both the enriched note data object and the selected position information to all computing devices 2601-2603 connected to the collaboration session.

The enriched note data object that is transmitted from local computing device 2601 to server 2600 and then from server 2600 to all computing devices 2601-2603 includes not only the text for display within the enriched note, but also the user settings and configurations (such as privacy controls, alerts, importance levels) and any content associated with the enriched note (such as content files or voice recordings). By ultimately storing a local copy of the enriched data object (including all content and settings), each user can interact with the enriched data object independently and not rely on the server to supply information in response to user interactions, thereby improving interaction response times and load on the server while still maintaining a uniform project planning collaboration workspace (since each enriched note appears at the same position across representations of the collaboration workspace).

Optionally, the server can store a copy of the enriched note data object and the position information in a server file repository or storage 2604. In the event that one of the clients (computing devices 2601-2603) is disconnected from the collaboration session, the server 2600 can then resupply the client with the relevant enriched note data objects and position information upon reconnection.

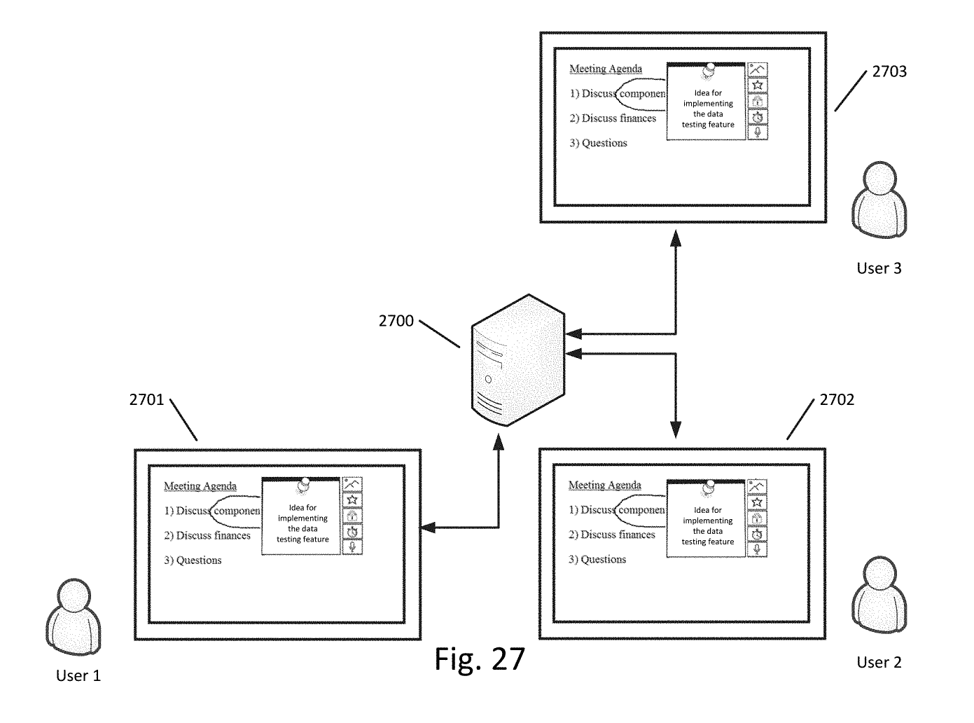

FIG. 27 illustrates the enriched note on multiple instances of a collaboration workspace according to an exemplary embodiment. As shown in FIG. 27, each representation of the collaboration workspace, including representations 2701, 2702, and 2703, displays a copy of the enriched note at the same selected position (designated by the creator of the enriched note data object). As discussed above, the enriched note data object corresponding to the enriched note is sent to all connected computing devices via the server 2700. Although each representation displays the same enriched note, User 1, User 2, and User 3 are free to interact with each of their respective enriched notes independently of one another.

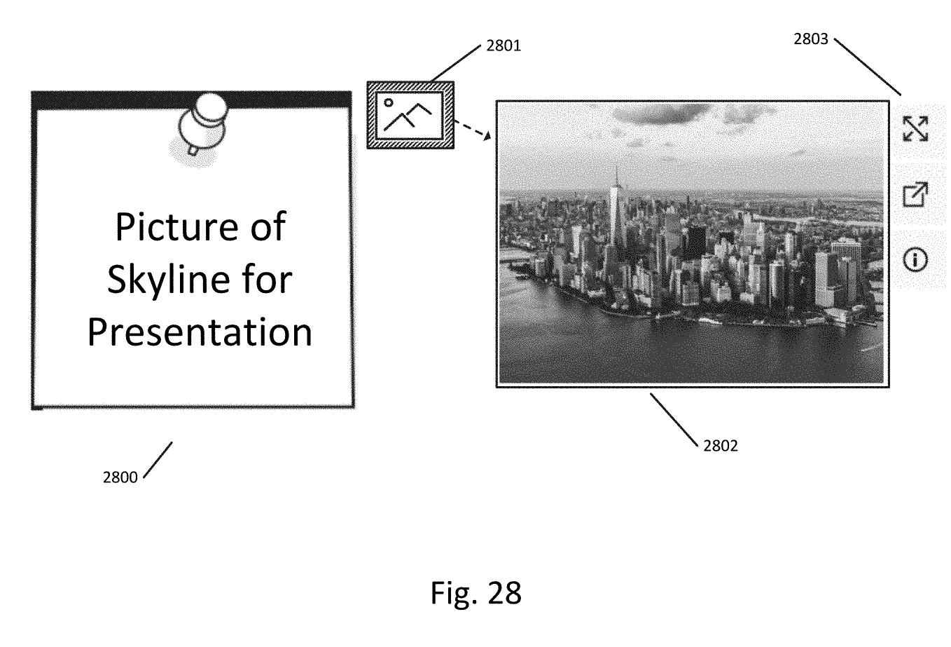

FIGS. 28-32 illustrate examples of user interaction with enriched notes according to an exemplary embodiment. FIG. 28 illustrates an enriched note 2800, having the display text “Picture of Skyline for Presentation,” in which the user has selected a display control 2801 icon. As a result of this selection, the associated content file (a picture) is displayed in an adjacent content display area 2802.

As discussed previously, the type of associated content file can be detected before rendering the enriched note 2800 and used to determine the type of icon used for the display control 2801. Additionally, the type of associated content file can be used to determine an appropriate application to initialize within the adjacent content display area 2802. For example, an associated document would result in the initialization of a word processing program within the adjacent display area 2802 whereas an associated video would result in the initialization of a media player within the adjacent display area.

The user can interact with the associated content file using one of the adjacent content browsing controls 2803. Content browsing controls 2803 allow the user to maximize the content window, scroll, navigate, or otherwise interact with the content, and provide information (such as metadata) about the content. For example, when the attached content is a video, the user can fast forward, rewind, or skip to different segments within the video.

Upon either deselecting the control 2801 or selecting some other user interface element that minimizes the associated content, the enriched note then reverts to its original form (e.g., as shown in FIG. 24).

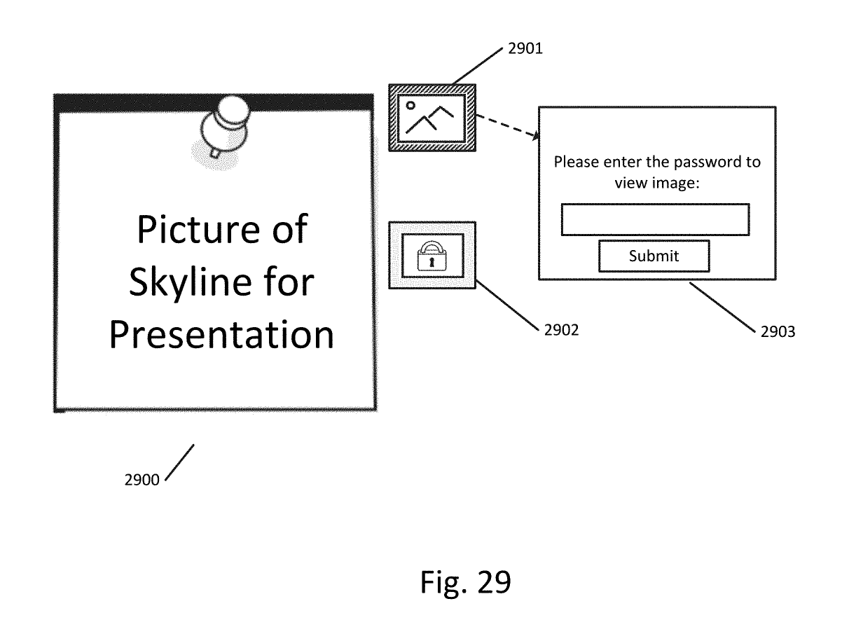

FIG. 29 illustrates an enriched note 2900 in which the creator has set a privacy control, resulting in the display of privacy control icon 2902. As shown in FIG. 29, upon selection of the display control 2901, a prompt 2903 is displayed requiring the user to enter a password in order to view the image. Optionally, the user can initiate this prompt 2903 by selecting the privacy control icon 2902 as well. Once the user successfully responds to the privacy control test by entering the correct password, the user is able to view the associated content in a format similar to the one shown in FIG. 28.

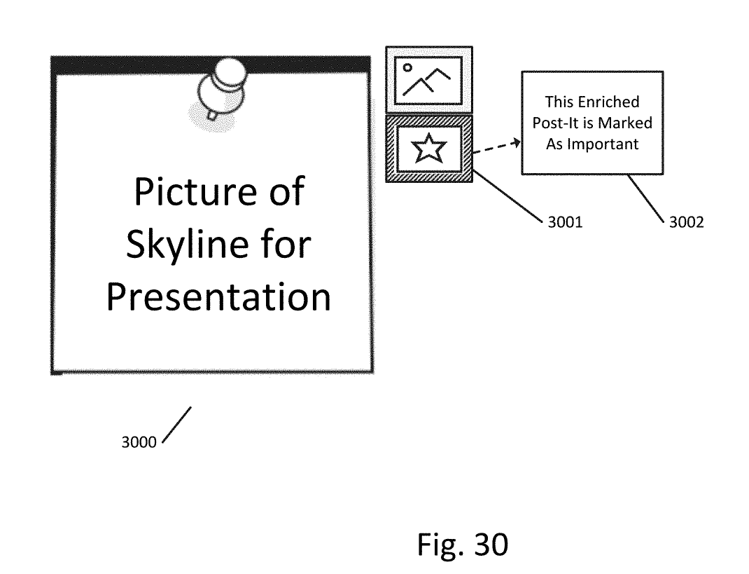

FIG. 30 illustrates an enriched note 3000 in which the creator has set an importance level of high. As shown in FIG. 30, if the user selects the corresponding importance indicator icon 3001, a prompt 3002 is displayed informing the user of the importance level of the enriched note 3000.

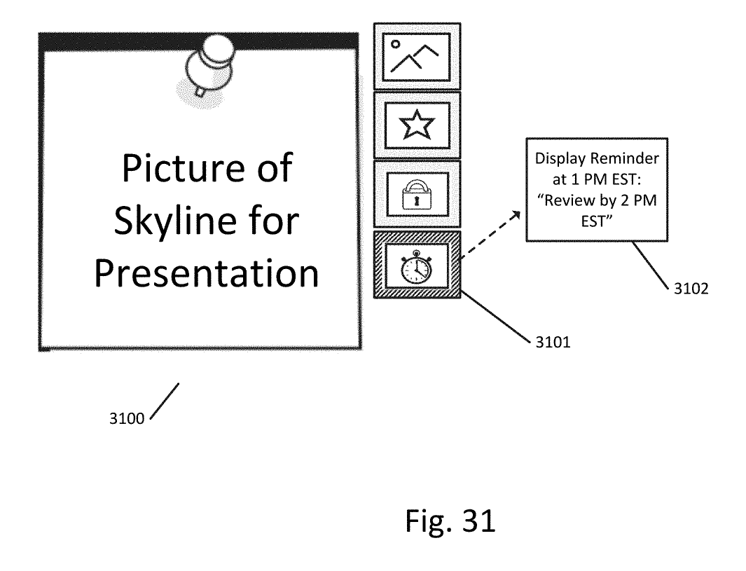

FIG. 31 illustrates an enriched note 3100 in which the creator has set an importance level of high, included access controls, and included an alert. As shown in FIG. 31, if the user selects the alert control icon 3101, a prompt 3102 is displayed informing the user of the associated alert notification. In this case, the alert notification is a message configured to be displayed at 1 PM EST that reminds the user to review the enriched note by 2 PM EST.

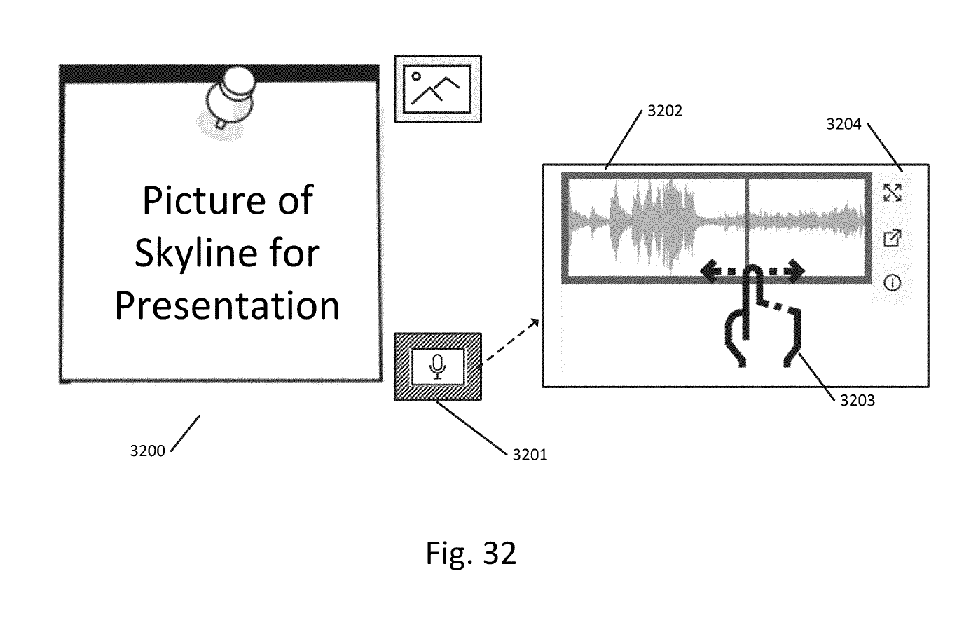

FIG. 32 illustrates an enriched note 3200 in which the creator has included a voice note. As shown in FIG. 32, if the user selects the voice note indicator icon 3201, a content display area 3202 is output with the replayable voice note. The user can browse and interact with the voice note through content browsing controls 3204 or directly, such as by using a pointing device or hand or touch gestures 3203, as shown in the figure. For example, the user can skip ahead to certain parts of the voice note.

The inputs received from users as part of the method for propagating enriched note data objects over a web socket connection in a networked collaboration workspace can be received via any type of pointing device, such as a mouse, touchscreen, or stylus. The earlier described techniques involving the virtual driver and/or the transparent layer can be used to detect inputs. For example, the input can be a pointing gesture by the user. Additionally, the actions described above, such as drag-and-drop actions, selection, deselection, or other inputs or sequences of inputs, can also be input using the earlier described techniques involving the virtual driver and/or transparent layer.

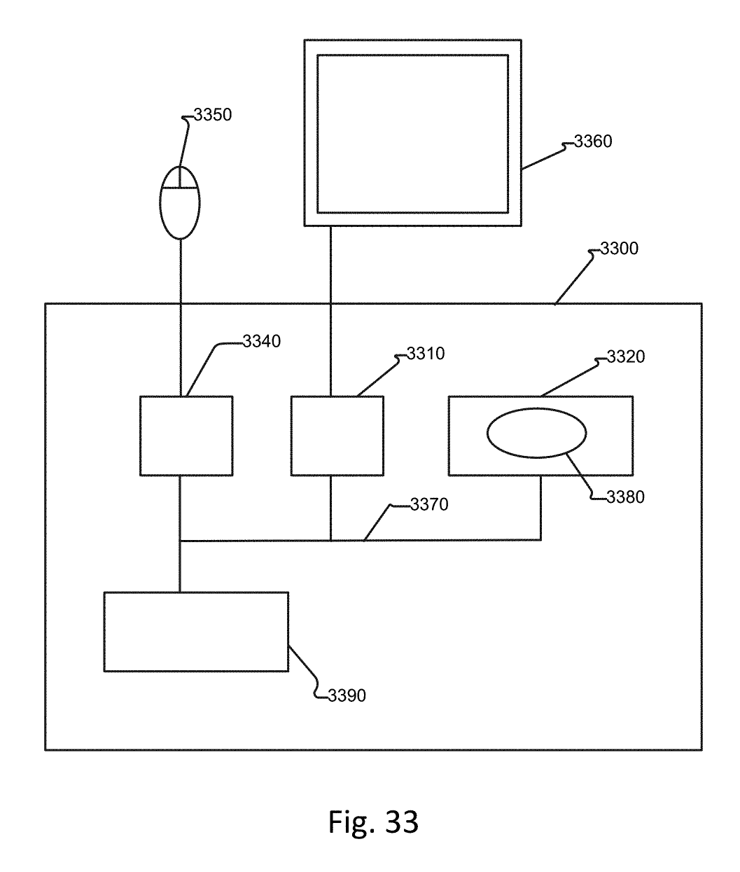

One or more of the above-described techniques can be implemented in or involve one or more computer systems. FIG. 33 illustrates an example of a specialized computing environment 3300. The computing environment 3300 is not intended to suggest any limitation as to scope of use or functionality of a described embodiment(s).

With reference to FIG. 33, the computing environment 3300 includes at least one processing unit 3310 and memory 3320. The processing unit 3310 executes computer-executable instructions and can be a real or a virtual processor. In a multi-processing system, multiple processing units execute computer-executable instructions to increase processing power. The memory 3320 can be volatile memory (e.g., registers, cache, RAM), non-volatile memory (e.g., ROM, EEPROM, flash memory, etc.), or some combination of the two. The memory 3320 can store software 3380 implementing described techniques.

A computing environment can have additional features. For example, the computing environment 3300 includes storage 3340, one or more input devices 3350, one or more output devices 3360, and one or more communication connections 3390. An interconnection mechanism 3370, such as a bus, controller, or network interconnects the components of the computing environment 3300. Typically, operating system software or firmware (not shown) provides an operating environment for other software executing in the computing environment 3300, and coordinates activities of the components of the computing environment 3300.

The storage 3340 can be removable or non-removable, and includes magnetic disks, magnetic tapes or cassettes, CD-ROMs, CD-RWs, DVDs, or any other medium which can be used to store information and which can be accessed within the computing environment 3300. The storage 3340 can store instructions for the software 3380.

The input device(s) 3350 can be a touch input device such as a keyboard, mouse, pen, trackball, touch screen, or game controller, a voice input device, a scanning device, a digital camera, remote control, or another device that provides input to the computing environment 3300. The output device(s) 3360 can be a display, television, monitor, printer, speaker, or another device that provides output from the computing environment 3300.

The communication connection(s) 3390 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the context of computer-readable media. Computer-readable media are any available media that can be accessed within a computing environment. By way of example, and not limitation, within the computing environment 3300, computer-readable media include memory 3320, storage 3340, communication media, and combinations of any of the above.

Of course, FIG. 33 illustrates computing environment 3300, display device 3360, and input device 3350 as separate devices for ease of identification only. Computing environment 3300, display device 3360, and input device 3350 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 3300 can be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method for propagating enriched note data objects over a web socket connection in a networked collaboration workspace, the method comprising:
transmitting, on a user interface of a local computing device, a representation of a collaboration workspace hosted on a server and accessible to a plurality of participants on a plurality of computing devices over a web socket connection;
generating, by the local computing device, an enriched note data object, the enriched note data object comprising text, one or more user-accessible controls, and at least one content file, wherein the enriched note data object is configured to display the text and the one or more user-accessible controls and further configured to open the at least one content file in response to selection of a display control in the one or more user-accessible controls;
detecting, by the local computing device, a user input associating the enriched note data object with a selected position in the representation of the collaboration workspace; and
transmitting, by the local computing device, the enriched note data object, the selected position, and one or more commands to the server over the web socket connection, the one or more commands being configured to cause the server to propagate the enriched note data object and the selected position to the plurality of computing devices.

2. The method of claim 1, wherein the enriched note data object is further configured to detect an application associated with the at least one content file.

3. The method of claim 2, wherein the enriched note data object is configured to open the at least one content file in response to selection of the display control in the one or more user-accessible controls by:
detecting selection of the display control;
initializing the application associated with the at least one content file in a content display area; and
loading the at least one content file in the initialized application.

4. The method of claim 3, wherein the enriched note data object is further configured to display the text and the one or more user-accessible controls in a primary display area and wherein content display area is adjacent to the primary display area.

5. The method of claim 1, wherein the one or more user-accessible controls comprise a privacy control and wherein the enriched note data object is further configured to:
determine whether there are any access control mechanisms associated with the enriched note data object in response to selection of either the display control or the privacy control;
conduct an authentication check based at least in part on a determination that the privacy control is activated prior to opening the at least one content file.

6. The method of claim 5, wherein the enriched note data object is further configured to deny access to the at least one content file if the authentication check is failed.

7. The method of claim 1, wherein the one or more user-accessible controls comprise an alert control and wherein the enriched note data object is further configured to:
receive a selection of an alert time and date and an alert notification via the alert control from a creator of the enriched note data object; and
transmit the alert notification on any computing device storing the enriched note data object at the alert time and date.

8. The method of claim 1, wherein the server comprises either the local computing device or a computing device in the plurality of computing devices.

9. The method of claim 1, wherein each computing device in the plurality of computing devices is configured to insert the enriched note data object into a local representation of the collaboration workspace at the selected position.

10. The method of claim 1, wherein the enriched note data object is configured to display the text and the one or more user-accessible controls in an enriched note user interface element defined by the enriched note data object.

11. A local computing device for propagating enriched note data objects over a web socket connection in a networked collaboration workspace, the local computing device comprising:
one or more processors; and
one or more memories operatively coupled to at least one of the one or more processors and having instructions stored thereon that, when executed by at least one of the one or more processors, cause at least one of the one or more processors to:
transmit, on a user interface of the local computing device, a representation of a collaboration workspace hosted on a server and accessible to a plurality of participants on a plurality of computing devices over a web socket connection;
generate an enriched note data object, the enriched note data object comprising text, one or more user-accessible controls, and at least one content file, wherein the enriched note data object is configured to display the text and the one or more user-accessible controls and further configured to open the at least one content file in response to selection of a display control in the one or more user-accessible controls;
detect a user input associating the enriched note data object with a selected position in the representation of the collaboration workspace; and
transmit the enriched note data object, the selected position, and one or more commands to the server over the web socket connection, the one or more commands being configured to cause the server to propagate the enriched note data object and the selected position to the plurality of computing devices.

12. The local computing device of claim 11, wherein the enriched note data object is further configured to detect an application associated with the at least one content file.

13. The local computing device of claim 12, wherein the enriched note data object is configured to open the at least one content file in response to selection of the display control in the one or more user-accessible controls by:
detecting selection of the display control;
initializing the application associated with the at least one content file in a content display area; and
loading the at least one content file in the initialized application.

14. The local computing device of claim 13, wherein the enriched note data object is further configured to display the text and the one or more user-accessible controls in a primary display area and wherein content display area is adjacent to the primary display area.

15. The local computing device of claim 11, wherein the one or more user-accessible controls comprise a privacy control and wherein the enriched note data object is further configured to:
determine whether there are any access control mechanisms associated with the enriched note data object in response to selection of either the display control or the privacy control;
conduct an authentication check based at least in part on a determination that the privacy control is activated prior to opening the at least one content file.

16. The local computing device of claim 15, wherein the enriched note data object is further configured to deny access to the at least one content file if the authentication check is failed.

17. The local computing device of claim 11, wherein the one or more user-accessible controls comprise an alert control and wherein the enriched note data object is further configured to:
receive a selection of an alert time and date and an alert notification via the alert control from a creator of the enriched note data object; and
transmit the alert notification on any computing device storing the enriched note data object at the alert time and date.

18. The local computing device of claim 11, wherein the server comprises either the local computing device or a computing device in the plurality of computing devices.

19. The local computing device of claim 11, wherein each computing device in the plurality of computing devices is configured to insert the enriched note data object into a local representation of the collaboration workspace at the selected position.

20. The local computing device of claim 11, wherein the enriched note data object is configured to display the text and the one or more user-accessible controls in an enriched note user interface element defined by the enriched note data object.

21. At least one non-transitory computer-readable medium storing computer-readable instructions that, when executed by a local computing device, causes the local computing device to:
transmit, on a user interface of the local computing device, a representation of a collaboration workspace hosted on a server and accessible to a plurality of participants on a plurality of computing devices over a web socket connection;
generate an enriched note data object, the enriched note data object comprising text, one or more user-accessible controls, and at least one content file, wherein the enriched note data object is configured to display the text and the one or more user-accessible controls and further configured to open the at least one content file in response to selection of a display control in the one or more user-accessible controls;
detect a user input associating the enriched note data object with a selected position in the representation of the collaboration workspace; and
transmit the enriched note data object, the selected position, and one or more commands to the server over the web socket connection, the one or more commands being configured to cause the server to propagate the enriched note data object and the selected position to the plurality of computing devices.

22. The at least one non-transitory computer-readable medium of claim 21, wherein the enriched note data object is further configured to detect an application associated with the at least one content file.

23. The at least one non-transitory computer-readable medium of claim 22, wherein the enriched note data object is configured to open the at least one content file in response to selection of the display control in the one or more user-accessible controls by:
detecting selection of the display control;
initializing the application associated with the at least one content file in a content display area; and
loading the at least one content file in the initialized application.

24. The at least one non-transitory computer-readable medium of claim 23, wherein the enriched note data object is further configured to display the text and the one or more user-accessible controls in a primary display area and wherein content display area is adjacent to the primary display area.

25. The at least one non-transitory computer-readable medium of claim 21, wherein the one or more user-accessible controls comprise a privacy control and wherein the enriched note data object is further configured to:
determine whether there are any access control mechanisms associated with the enriched note data object in response to selection of either the display control or the privacy control;
conduct an authentication check based at least in part on a determination that the privacy control is activated prior to opening the at least one content file.

26. The at least one non-transitory computer-readable medium of claim 25, wherein the enriched note data object is further configured to deny access to the at least one content file if the authentication check is failed.

27. The at least one non-transitory computer-readable medium of claim 21, wherein the one or more user-accessible controls comprise an alert control and wherein the enriched note data object is further configured to:
receive a selection of an alert time and date and an alert notification via the alert control from a creator of the enriched note data object; and
transmit the alert notification on any computing device storing the enriched note data object at the alert time and date.

28. The at least one non-transitory computer-readable medium of claim 21, wherein the server comprises either the local computing device or a computing device in the plurality of computing devices.

29. The at least one non-transitory computer-readable medium of claim 21, wherein each computing device in the plurality of computing devices is configured to insert the enriched note data object into a local representation of the collaboration workspace at the selected position.

30. The at least one non-transitory computer-readable medium of claim 21, wherein the enriched note data object is configured to display the text and the one or more user-accessible controls in an enriched note user interface element defined by the enriched note data object.
